(19) United States
(12) Patent Application Publication
(10) Pub. No.: US 2024/0370916 A1
(43) Pub. Date: Nov. 7, 2024

(54) Systems, Methods and User Interfaces for Organizing Wish Lists in Online Marketplaces

(71) Applicant: Airbnb, Inc., San Francisco, CA (US)

(72) Inventors: Matthew TALMA, San Francisco, CA (US); Laura MATSUURA, San Francisco, CA (US)

(21) Appl. No.: 18/653,848

(22) Filed: May 2, 2024

Related U.S. Application Data
(60) Provisional application No. 63/499,648, filed on May 2, 2023.

(51) Int. Cl. G06Q 30/0601

(52) U.S. Cl. CPC G06Q 30/0633; G06Q 30/0643

(57) ABSTRACT

A method is provided for organizing wish lists in an online marketplace. The method includes displaying, on a wish list management graphical user interface, category affordances corresponding to properties available in the online marketplace. In response to detecting an input from a user to select a category affordance, the method includes displaying property cards. Each property card corresponds to properties for a category corresponding to the category affordance. The method also includes displaying wish list icons. Each wish list icon corresponds to a respective property card. In response to detecting a selection of a wish list icon, the method includes generating a wish list for the category and associating a property corresponding to the wish list icon with a wish list for the category. In response to detecting the user selecting an option to view a wish list, the method includes displaying one or more properties of a wish list.

### RELATED APPLICATIONS

This application claims priority to U.S. Provisional Application Ser. No. 63/499,648, filed May 2, 2023, entitled “Systems, Methods and User Interfaces for Organizing Wish Lists in Online Marketplaces,” which is incorporated by reference herein in its entirety.

### TECHNICAL FIELD

This application relates generally to special-purpose machines that manage interfaces and data processing and improvements to such variants, and to the technologies by which such special-purpose machines become improved compared to other special-purpose machines for online marketplaces.

### BACKGROUND

Web or cloud-based systems may help users perform a variety of tasks, a common one being e-commerce websites that permit users to buy, rent, or reserve products and/or services. Typically, the customer user of such a site performs such tasks (e.g., purchasing, renting) themselves, using the website as a tool for facilitating the transaction. Before a user rents a property, the user may perform a variety of searches. Narrowing searches is a cumbersome process that may include multiple rounds of searches and may include different modalities. In this process, the user needs to be able to track their progress and organize search results.

### SUMMARY

Technical solutions for more personalized, dynamic, accurate, and timely management of wish lists in online marketplaces are therefore generally desired.

The disclosed implementations provide a method of organizing wish lists in an online marketplace. The method includes obtaining a wish list for a user. The wish list includes one or more properties. The method also includes displaying, on a wish list management graphical user interface, one or more property cards. Each property card corresponds to a respective property of the one or more properties in the wish list. The method also includes displaying, on the wish list management graphical user interface, one or more note addition affordances for adding notes for the one or more properties. Each note addition affordance is associated with a respective property. The method also includes, in response to detecting, on the wish list management graphical user interface, a first input from the user to select a first note addition affordance of the one or more affordances, displaying a first note addition overlay to add a first note for a first property of the one or more properties. The method also includes, in response to detecting, on the wish list management graphical user interface, a second user input in the first note addition overlay to enter a first text, associating the first text with the first property. The method also includes ceasing to display the first note addition overlay and resuming displaying the one or more property cards and the one or more note addition affordances. The method also includes displaying, on the wish list management graphical user interface, the first text along with a first property card of the one or more property cards. The first property card corresponds to the first property.

Some embodiments enable users to update notes. The method further includes, in response to detecting, on the wish list management graphical user interface, a third input from the user to select the first note addition affordance, displaying a second note addition overlay to add a second note for the first property. The method also includes, in response to detecting, on the wish list management graphical user interface, a fourth user input in the second note addition overlay to enter a second text, associating the second text with the first property. The method also includes ceasing to display the second note addition overlay and resuming displaying the one or more property cards and the one or more note addition affordances. The method also includes displaying, on the wish list management graphical user interface, the second text, instead of the first text, along with the first property card of the one or more property cards, wherein the first property card corresponds to the first property.

Some embodiments enable users to sort the cards and/or property listings in the wish lists based on notes. In some embodiments, the method further includes sorting the one or more property cards based on notes corresponding to each property of the one or more properties, to obtain a sorted list of property cards. The method also includes displaying, on the wish list management graphical user interface, the one or more property cards, according to the sorted list of property cards.

In some embodiments, each note addition affordance of the one or more note addition affordances is shown adjacent to a respective property card of a respective property corresponding to the respective note addition affordance.

Some embodiments enable users to share wish list and/or shares notes. In some embodiments, the method further includes providing a share affordance on the wish list management graphical user interface. The method also includes, in response to the user selecting the share affordance, (i) displaying, on the wish list management graphical user interface, a wish list share overlay to select a share option for the user to share the wish list; and (ii) in response to the user selecting, on the wish list management graphical user interface, the share option, associating one or more other users of the online marketplace to share the wish list and/or displaying the wish list for the one or more other users. In some embodiments, associating the one or more other users of the online marketplace is performed in response to the user (i) providing information related to the one or more other users and/or (ii) selecting a mechanism to share the wish list with the one or more other users, via the wish list management graphical user interface.

Some embodiments show a map alongside a wish list. In some embodiments, the method further includes dividing the wish list management graphical user interface into a plurality of regions. The method also includes displaying the one or more property cards in a first region of the wish list management graphical user interface. The method also includes displaying a map in a second region of the wish list management graphical user interface. The method also includes displaying a plurality of icons on the map, each icon corresponding to a respective property of the one or more properties. Each icon is displayed approximately at a geographic location on the map corresponding to the respective property. In some embodiments, the first region and the second region are displayed concurrently and adjacent to each other. In some embodiments, the first region and the second region are displayed concurrently, and the first region is displayed above the second region. In some embodiments, the first region and the second region have different areas. In some embodiments, the first region and the second region have similar areas. In some embodiments, the map corresponds to a geographic region corresponding to a location of the one or more properties in the wish list. In some embodiments, the method further includes displaying, in the first region, a subset of the one or more property cards including less than all property cards of the one or more property cards. The method also includes displaying, in the second region, a portion of the map lesser than a whole of the map, based on an area of the second region. In some embodiments, the method further includes selecting the portion of the map so as to show locations corresponding to the subset of properties corresponding to the subset of the one or more property cards. In some embodiments, the method further includes selecting the subset of the one or more property cards based on relative importance of properties for the user. In some embodiments, a sum of areas of the plurality of regions corresponds to a screen size of a device used by the user.

Some embodiments enable users to filter wish list based on selected dates and/or show thumbnail images for properties available during selected dates. Some embodiments provide a method of organizing wish lists in an online marketplace. The method includes obtaining a wish list for a user, the wish list including one or more properties. The method also includes displaying, on a wish list management graphical user interface, one or more property cards, each property card corresponding to a respective property of the one or more properties in the wish list. The method also includes displaying, on the wish list management graphical user interface, a filter option to filter the wish list based on dates. The method also includes, in response to detecting a first input from the user to select the filter option, displaying, on the wish list management graphical user interface, a calendar overlay that shows a calendar with a date affordance to select dates. The method also includes, in response to the user selecting the date affordance to select dates and before confirmation of the dates from the user, while maintaining display of the calendar overlay on the wish list management graphical user interface, displaying, in a region in the calendar overlay, thumbnail images corresponding to properties of the one or more properties that are available during selected dates.

In some embodiments, the thumbnail images are shown below the calendar. In some embodiments, the region is displayed below the calendar.

Some embodiments filter after dates are selected by a user. In some embodiments, the method further includes, after receiving confirmation of the dates from the user: ceasing to display the calendar overlay; and displaying, on the wish list management graphical user interface, only the properties of the one or more properties that are available during the selected dates.

Some embodiments update thumbnail images real-time. In some embodiments, the thumbnail images are updated in real time in response to date changes.

Some embodiments show available properties in wish list followed by unavailable properties. In some embodiments, the method further includes ceasing to display the calendar overlay, and sorting and displaying, on the wish list management graphical user interface, the properties of the one or more properties that are available during the selected dates followed by other properties of the one or more properties that are not available during the selected dates.

Some embodiments show number of available properties. In some embodiments, the method further includes displaying, in the region, adjacent to the thumbnail images, a number of available properties for the selected dates.

Some embodiments enable users to select exact dates and/or dates with leeway (e.g., +/−1, +/−2, etc.) for the wish lists. In some embodiments, the method further includes displaying, in the region, one or more affordances for selecting exact dates or dates with leeway.

In some embodiments, the method further includes, in response to the user selecting an affordance corresponding to dates with leeway, updating the region with an updated set of thumbnail images corresponding to an updated set of properties of the one or more properties that are available during the dates with leeway.

Some embodiments enable users to save properties to a known wish list. A method of organizing wish lists in an online marketplace is provided, according to some embodiments. The method includes displaying, on a wish list management graphical user interface, one or more category affordances, each category affordance corresponding to a respective category of one or more categories of properties available in the online marketplace. The method also includes, in response to detecting, on the wish list management graphical user interface, a first input from a user to select a first category affordance of the one or more category affordances, displaying a first one or more property cards, on the wish list management graphical user interface. Each property card of the first one or more property cards corresponds to a respective property of a first one or more properties for a first category corresponding to the first category affordance. The method also includes, displaying, on the wish list management graphical user interface, a first one or more wish list icons, each wish list icon corresponding to a respective property card of the first one or more property cards. The method also includes, in response to detecting, on the wish list management graphical user interface, a selection by a user of a first wish list icon of the first one or more wish list icons, generating a first wish list for the first category and associating a first property corresponding to the first wish list icon with a first wish list for the first category. The method also includes, displaying, on the wish list management graphical user interface, an option to view wish lists created by the user. The method also includes, in response to detecting, the user selecting, on the wish list management graphical user interface, the option to view lists, displaying a set of wish list affordances, each wish list affordance corresponding to a respective wish list of the wish lists created by the user. The method also includes, in response to detecting, the user selecting, on the wish list management graphical user interface, a first wish list affordance corresponding to the first wish list, displaying, on the wish list management graphical user interface, a first property card corresponding to the first property associated with the first wish list.

Some embodiments enable users to switch between wish lists. In some embodiments, the method further includes, in response to detecting, on the wish list management graphical user interface, a second input from the user to select a second category affordance of the one or more category affordances, displaying a second one or more property cards, on the wish list management graphical user interface, each property card of the second one or more property cards corresponding to a respective property of a second one or more properties for a second category corresponding to the second category affordance. The method also includes displaying, on the wish list management graphical user interface, a second one or more icons, each icon of the second one or more icons corresponding to a respective property card of the second one or more property cards. The method also includes, in response to detecting, the user selecting, on the wish list management graphical user interface, a third icon of the second one or more icons, associating a third property corresponding to the third icon with a second wish list for the second category. The method also includes, in response to detecting, the user selecting, on the wish list management graphical user interface, a fourth icon of the second one or more icons, associating a fourth property corresponding to the fourth icon with the second wish list for the first category. The method also includes, in response to detecting, the user selecting, on the wish list management graphical user interface, the option to view lists, displaying the set of wish list affordances including the first wish list and the second wish list.

Some embodiments enable users to add to a wish list for a category. In some embodiments, the method further includes, in response to detecting, the user selecting, on the wish list management graphical user interface, a second icon of the first one or more wish list icons, associating a second property corresponding to the second icon with the first wish list for the first category.

In another aspect, an electronic device includes one or more processors, memory, a display, and one or more programs stored in the memory. The programs are configured for execution by the one or more processors and are configured to perform any of the methods described herein.

In another aspect, a non-transitory computer readable storage medium stores one or more programs configured for execution by a computing device having one or more processors, memory, and a display. The one or more programs are configured to perform any of the methods described herein.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram illustrating an exemplary wish list management system implemented in a networked environment, in accordance with some embodiments.

FIG. 2 is a block diagram illustrating the architecture of software used to implement the wish list management system, according to some embodiments.

FIG. 3 shows a machine as an example computer system with instructions to cause the machine to implement the wish list management system, according to some embodiments.

FIG. 4 illustrates an example user interface for viewing and/or managing wish lists of properties, according to some embodiments.

FIG. 5A illustrates an example user interface for viewing and/or managing a wish list of properties, for adding notes to wish lists according to some embodiments.

FIG. 5B shows another view of the example user interface shown in FIG. 5A, according to some embodiments.

FIG. 6A illustrates an example user interface for adding a note for a property of wish list, according to some embodiments.

FIG. 6B shows another view of the example user interface shown in FIG. 6A after a user starts typing a text to add notes for a property listing, according to some embodiments.

FIG. 6C shows another view of the example user interface shown in FIG. 6A after a user selects a different image or view for the property listing, according to some embodiments.

FIG. 6D shows another view of the example user interface shown in FIG. 6A after a user selects a different image or view for the property listing, according to some embodiments.

FIG. 6E shows another view of the example user interface shown in FIG. 6A after a user saves a note for a property listing of a wish list, according to some embodiments.

FIG. 6F shows another view of the example user interface shown in FIG. 6A for property listings of a wish list, according to some embodiments.

FIG. 6G shows another view of the example user interface shown in FIG. 6A for property listings of a wish list, according to some embodiments.

FIG. 6H shows another view of the example user interface shown in FIG. 6A after a user saves an additional note for the property listing of a wish list, according to some embodiments.

FIG. 6I shows another view of the example user interface shown in FIG. 6A after a user enters additional text for notes for the property listing of a wish list, according to some embodiments.

FIG. 7A illustrates an example user interface for sharing a wish list, according to some embodiments.

FIG. 7B shows another view of the example user interface shown in FIG. 7A after a user selects to share a link to a wish list, according to some embodiments.

FIG. 8A illustrates an example user interface for selecting dates for properties in a wish list and/or filtering properties in a wish list by date, according to some embodiments.

FIG. 8B shows another view of the example user interface shown in FIG. 8A after a user selects a different start date, according to some embodiments.

FIG. 8C shows another view of the example user interface shown in FIG. 8A for flexible dates, according to some embodiments.

FIG. 8D shows another view of the example user interface shown in FIG. 8A after a user selects different dates, according to some embodiments.

FIG. 8E shows another view of the example user interface shown in FIG. 8A after a user selects dates for a wish list, according to some embodiments.

FIG. 8F shows another view of the example user interface shown in FIG. 8A that shows properties in a wish list that are unavailable, according to some embodiments.

FIG. 9A illustrates an example user interface for easy saves to wish lists, according to some embodiments.

FIG. 9B shows another view of the example user interface shown in FIG. 9A that shows properties for the mansions category, according to some embodiments.

FIG. 9C shows another view of the example user interface shown in FIG. 9A after the user has selected to view wish lists, according to some embodiments.

FIG. 9D shows another view of the example user interface shown in FIG. 9A after the user has selected to create a new wish list, according to some embodiments.

FIG. 9E shows another view of the example user interface shown in FIG. 9A after a user selects to view wish lists, according to some embodiments.

FIG. 9F shows another view of the example user interface shown in FIG. 9A after a user selects to view a wish list, according to some embodiments.

FIG. 9G shows another view of the example user interface shown in FIG. 9A after a user selects a different category, according to some embodiments.

FIG. 9H shows another view of the example user interface shown in FIG. 9A after a user selects an affordance for adding a property to a wish list, according to some embodiments.

FIG. 9I shows another view of the example user interface shown in FIG. 9A when a user selects a category, according to some embodiments.

FIG. 10 shows a flow diagram of a method for organizing wish lists in an online marketplace, according to some embodiments.

FIG. 11 shows a flow diagram of a method for organizing wish lists in an online marketplace, according to some embodiments.

FIGS. 12A and 12B show a flow diagram of a method for organizing wish lists in an online marketplace, according to some embodiments.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

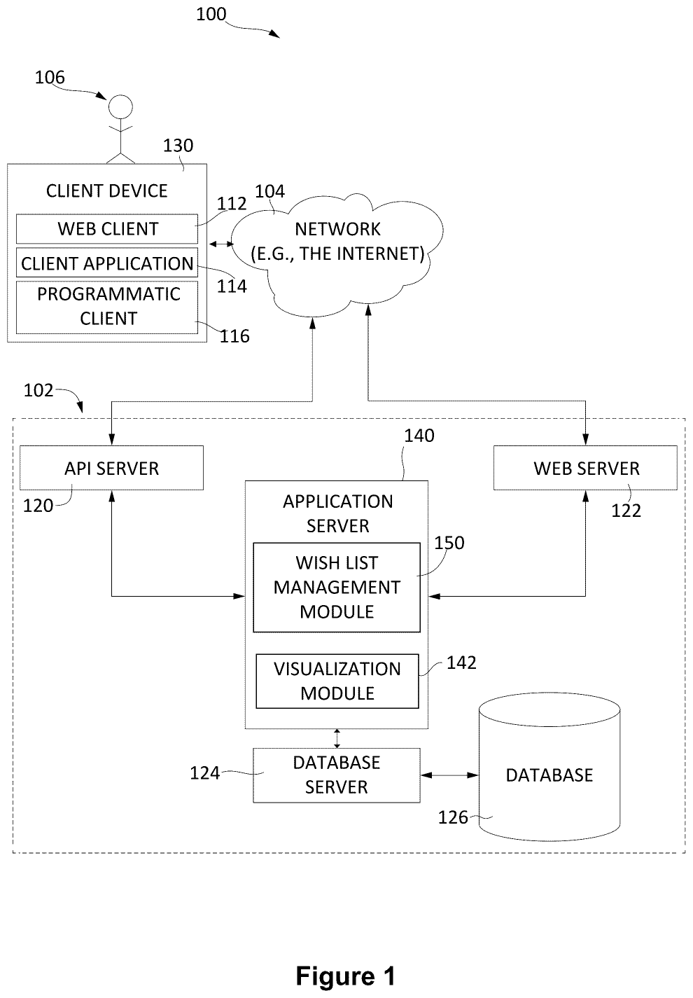

FIG. 1 shows a block diagram of a network architecture 100 for an optimized search system according to some embodiments. FIG. 1 illustrates, for example, a web client 112 (e.g., a browser), client application(s) 114, and a programmatic client 116 executing on a client device 130. The client device 130 includes a web client 112, client application(s) 114, and a programmatic client 116 alone, together, or in any suitable combination. Although FIG. 1 shows one client device 130, in some embodiments, the network architecture 100 comprises multiple client devices.

In some embodiments, the client device 130 comprises a computing device that includes at least a display and communication capabilities that provide access to a networked system 102 via a network 104. The client device 130 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultra-book, netbook, laptop, desktop, multi-processor system, microprocessor-based or programmable consumer electronic, game consoles, set-top box (STB), network personal computer (PC), mini-computer, and so forth. In some embodiments, the client device 130 comprises one or more of a touch screens, accelerometer, gyroscope, biometric sensor, camera, microphone, Global Positioning System (GPS) device, and the like.

The client device 130 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or any suitable combination thereof.

In some embodiments, the client device 130 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and reservation applications for temporary stays at hotels, motels, or residences managed by other end-users (e.g., a posting end-user who owns a home and rents out the entire home or private room). In some embodiments, the client application(s) 114 include various components operable to present information to the user and communicate with the networked system 102. In some embodiments, if an e-commerce site application is included in the client device 130, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the e-commerce site application is not included in the client device 130, the client device 130 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via a programmatic interface provided by an Application Program Interface (API) server 120.

Users (e.g., user 106) comprise a person, a machine, or other means of interacting with the client device 130. In some embodiments, the user 106 is not part of the network architecture 100, but interacts with the network architecture 100 via the client device 130 or another means. For instance, the user 106 provides input (e.g., touch screen input or alphanumeric input) to the client device 130 and the input is communicated to the networked system 102 via the network 104. In this instance, the networked system 102, in response to receiving the input from the user 106, communicates information to the client device 130 via the network 104 to be presented to the user 106. In this way, the user 106 can interact with the networked system 102 using the client device 130.

The API server 120 and the web server 122 are coupled to, and provide programmatic and web interfaces respectively to, one or more application server(s) 140. The application server 140 is configured to manage wish lists in response to inputs from a client device 130. The client device 130 may be used by a user of an online marketplace. The wish list may include properties listed in the online marketplace. The wish list may be a collection of data stored on a database including a listing of one or more unique identifiers associated with products and/or services offered for sale at an online marketplace. The wish list may include properties selected by the user for triaging purposes. For example, a user planning a trip, a travel, or a vacation, goes through a process of triaging or shortlisting before selecting the properties for purchase and/or renting. In this process, the user may create several wish lists, add notes, share these notes and/or the wish lists with other users. The wish lists may be organized based on categories or attributes of properties listed in the online marketplace. When the user selects properties, the properties may be automatically added to a wish list corresponding to a current focus or category of the properties. When the focus shifts, the properties selected by the user may be automatically saved to a new wish list corresponding to the new category or attribute.

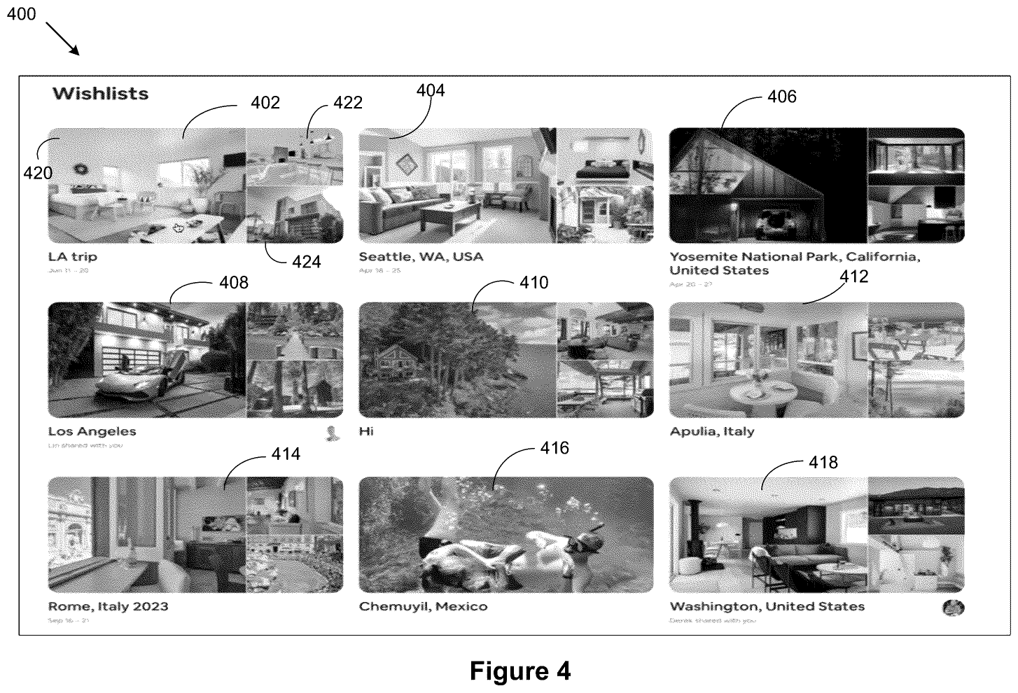

The application server(s) 140 include a wish list management module 150 to organize wish lists for users in an online marketplace. The application server(s) 140 also include a visualization module 142 to generate and/or display visualizations in a graphical user interface. Property listings, wish lists, categories or attributes of properties, visualizations, related parameters, and/or user preferences may be stored as part of the wish list management module 150 and/or the visualization module 142. These modules may comprise one or more modules or applications and each of which can be embodied as hardware, software, firmware, or any combination thereof to facilitate optimizing the search results for the client device 130. The application server(s) 140 are, in turn, shown to be coupled to one or more database server(s) 124 that facilitate access to one or more information storage repositories or database(s) 126. In some embodiments, the database(s) 126 are storage devices that store information to be posted (e.g., inventory, image data, catalog data, feature vectors) to the visualization module 142, and/or the wish list management module 150. The database(s) 126 also stores digital goods information in accordance with some embodiments. The wish list management module 150 may manage, store and/or retrieve wish lists, property listings, notes for properties, user preferences, historical usage data, categories and/or attributes for properties (e.g., locations, names, ratings), availability of properties. The visualization module 142 may manage, store and/or retrieve user interface properties (e.g., a mobile phone has a different screen size, dimensions and/or form factor when compared to a desktop) and/or parameters, property cards, process user inputs received via graphical user interfaces, overlays, images and/or thumbnail images for properties, icons and/or affordances, maps, and/or user preferences, preferences of users of the online marketplace, historical usage data for visualizations and displays. Operations of the modules are described below in reference to FIGS. 4-12B, according to one or more embodiments.

While the network architecture 100 shown in FIG. 1 employs a client-server architecture, the present inventive subject matter is, of course, not limited to such an architecture, and can equally be implemented in a distributed, or peer-to-peer, architecture system, for example. The various components of the applications server(s) 140 (e.g., the visualization module 142, and/or the wish list management module 150) may also be implemented as standalone software programs, which do not necessarily have networking capabilities.

Although the modules are shown in FIG. 1 as components of the networked system 102, it will be appreciated that, in alternative embodiments, each may be a component in a web service that is separate and distinct from the networked system 102. The visualization module 142, and/or the wish list management module 150, can each be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124.

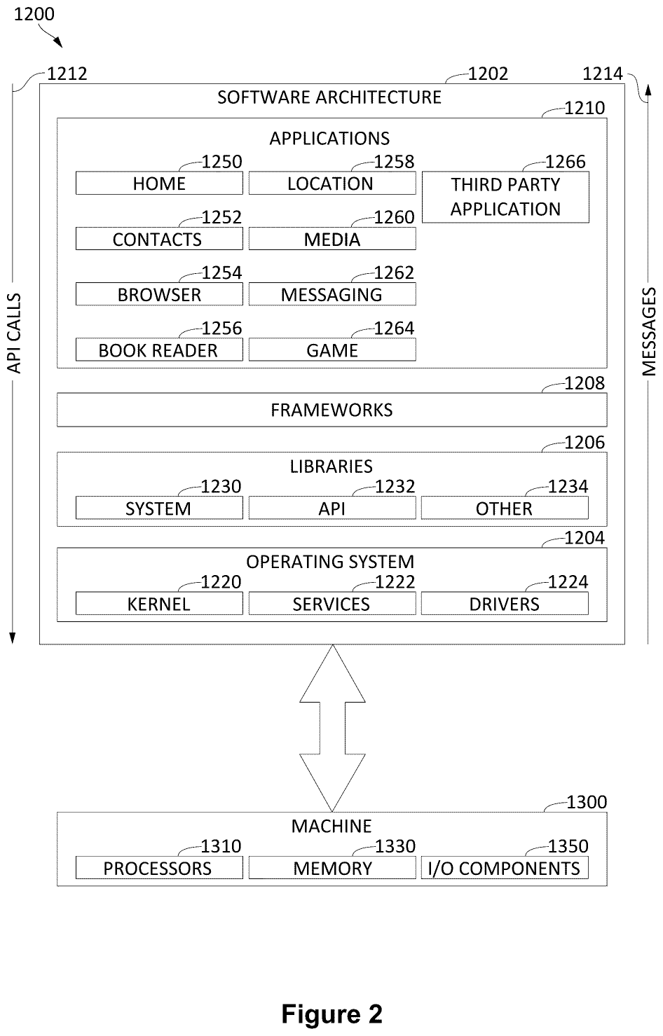

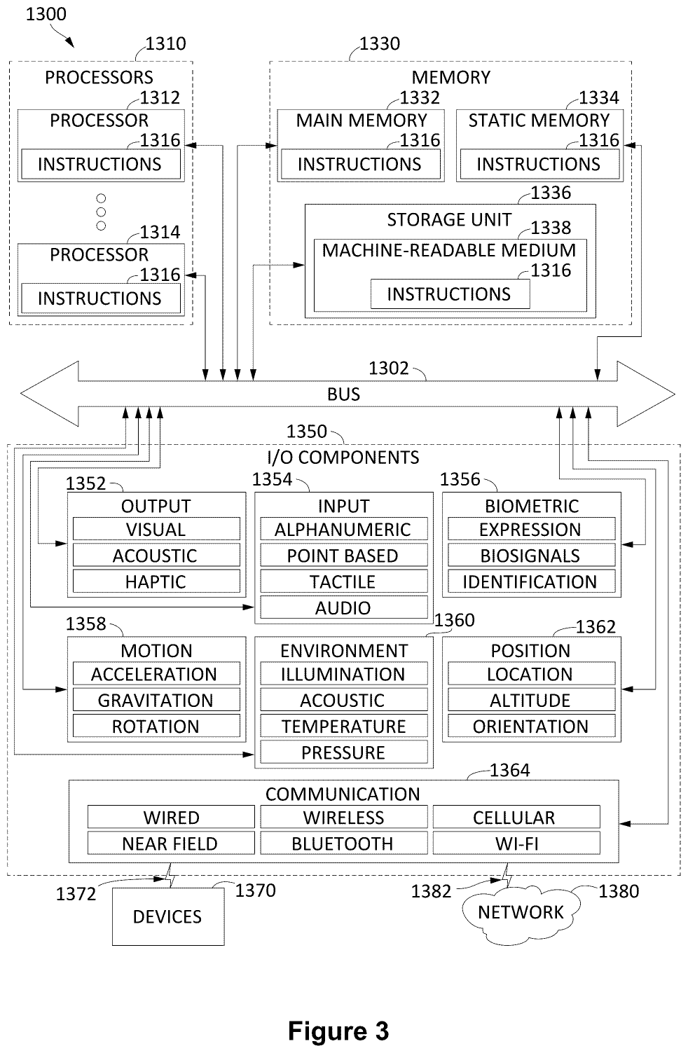

FIG. 2 is a block diagram 200 illustrating an architecture of software 202, which can be installed on any one or more of the devices described above. FIG. 2 is merely a non-limiting example of a software architecture, and it will be appreciated that many other architectures can be implemented to facilitate the functionality described herein. In various embodiments, software 202 is implemented by hardware such as a machine 300 (further described in FIG. 3) that includes processors 310, memory 330, and input/output (I/O) components 350. In this example architecture, the software 202 can be conceptualized as a stack of layers where each layer may provide a particular functionality. For example, the software 202 includes layers such as an operating system 204, libraries 206, frameworks 208, and applications 210. Operationally, the applications 210 invoke API calls 212 through the software stack and receive messages 214 in response to the API calls 212, consistent with some embodiments.

In various implementations, the operating system 204 manages hardware resources and provides common services. The operating system 204 includes, for example, a kernel 220, services 222, and drivers 224. The kernel 120 acts as an abstraction layer between the hardware and the other software layers, consistent with some embodiments. For example, the kernel 220 provides memory management, processor management (e.g., scheduling), component management, networking, and security settings, among other functionalities. The services 222 can provide other common services for the other software layers. The drivers 224 are responsible for controlling or interfacing with the underlying hardware, according to some embodiments. For instance, the drivers 224 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 206 provide a low-level common infrastructure utilized by the applications 210. The libraries 206 can include system libraries 230 (e.g., C standard library) that can provide functions such as memory allocation functions, string manipulation functions, mathematic functions, and the like. In addition, the libraries 206 can include API libraries 232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 206 can also include a wide variety of other libraries 234 to provide many other APIs to the applications 210.

The frameworks 208 provide a high-level common infrastructure that can be utilized by the applications 210, according to some embodiments. For example, the frameworks 208 provide various graphic user interface (GUI) functions, high-level resource management, high-level location services, and so forth. The frameworks 208 can provide a broad spectrum of other APIs that can be utilized by the applications 210, some of which may be specific to a particular operating system or platform.

In some embodiments, the applications 210 include a home application 250, a contacts application 252, a browser application 254, a book reader application 256, a location application 258, a media application 260, a messaging application 262, a game application 264, and/or a broad assortment of other applications, such as a third-party application 266. According to some embodiments, the applications 210 are programs that execute functions defined in the programs. Various programming languages can be employed to create one or more of the applications 210, structured in a variety of manners, such as object-oriented programming languages (e.g., Objective-C, Java, or C++) or procedural programming languages (e.g., C or assembly language). In a specific example, the third-party application 266 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 266 can invoke the API calls 212 provided by the operating system 204 to facilitate the functionality described herein.

FIG. 3 illustrates a diagrammatic representation of a machine 300 in the form of a computer system within which a set of instructions may be executed for causing the machine to perform any one or more of the methodologies discussed herein, according to some embodiments. Specifically, FIG. 3 shows a diagrammatic representation of the machine 300 in the example form of a computer system, within which instructions 316 (e.g., software, a program, an application, an applet, an app, or other executable code) for causing the machine 300 to perform any one or more of the methodologies discussed herein may be executed. The instructions 316 transform the general, non-programmed machine 300 into a particular machine 300 programmed to carry out the described and illustrated functions in the manner described. In alternative embodiments, the machine 300 operates as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a PC, a tablet computer, a laptop computer, a netbook, an STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 316, sequentially or otherwise, that specify actions to be taken by the machine 300. Further, while only a single machine 300 is illustrated, the term “machine” shall also be taken to include a collection of machines 300 that individually or jointly execute the instructions 316 to perform any one or more of the methodologies discussed herein.

The machine 300 may include processors 310, memory 330, and I/O components 350, which may be configured to communicate with each other such as via a bus 302. In some embodiments, the processors 310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 312 and a processor 314 that may execute the instructions 316. The term “processor” is intended to include multi-core processors that may comprise two or more independent processors (sometimes referred to as “cores”) that may execute instructions contemporaneously. Although FIG. 3 shows multiple processors 310, the machine 300 may include a single processor with a single core, a single processor with multiple cores (e.g., a multi-core processor), multiple processors with a single core, multiple processors with multiples cores, or any combination thereof.

The memory 330 may include a main memory 332, a static memory 334, and a storage unit 336, all accessible to the processors 310 such as via the bus 302. The main memory 332, the static memory 334, and storage unit 336 store the instructions 316 embodying any one or more of the methodologies or functions described herein. The instructions 316 may also reside, completely or partially, within the main memory 332, within the static memory 334, within the storage unit 336, within at least one of the processors 310 (e.g., within the processor's cache memory), or any suitable combination thereof, during execution thereof by the machine 300.

The I/O components 350 may include a wide variety of components to receive input, provide output, produce output, transmit information, exchange information, capture measurements, and so on. The specific I/O components 350 that are included in a particular machine will depend on the type of machine. For example, portable machines such as mobile phones will likely include a touch input device or other such input mechanisms, while a headless server machine will likely not include such a touch input device. It will be appreciated that the I/O components 350 may include many other components that are not shown in FIG. 3. The I/O components 350 are grouped according to functionality merely for simplifying the following discussion and the grouping is in no way limiting. In various embodiments, the I/O components 350 may include output components 352 and input components 354. The output components 352 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 354 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some embodiments, the I/O components 350 may include biometric components 356, motion components 358, environmental components 360, or position components 362, among a wide array of other components. For example, the biometric components 356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. Any biometric data collected by the biometric components is captured and stored only with user approval and deleted on user request. Further, such biometric data may be used for limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information. The motion components 358 may include acceleration sensor components (e.g., accelerometer), gravitation sensor components, rotation sensor components (e.g., gyroscope), and so forth. The environmental components 360 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 362 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 350 may include communication components 364 operable to couple the machine 300 to a network 380 or devices 370 via a coupling 382 and a coupling 372, respectively. For example, the communication components 364 may include a network interface component or another suitable device to interface with the network 380. In further examples, the communication components 364 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 370 may be another machine or any of a wide variety of peripheral devices (e.g., a peripheral device coupled via a USB).

Moreover, the communication components 364 may detect identifiers or include components operable to detect identifiers. For example, the communication components 364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 364, such as location via Internet Protocol (IP) geolocation, location via Wi-Fi® signal triangulation, location via detecting an NFC beacon signal that may indicate a particular location, and so forth.

The various memories (i.e., 330, 332, 334, and/or memory of the processor(s) 310) and/or storage unit 336 may store one or more sets of instructions and data structures (e.g., software) embodying or utilized by any one or more of the methodologies or functions described herein. These instructions (e.g., the instructions 316), when executed by processor(s) 310, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various embodiments, one or more portions of the network 380 may be an ad hoc network, an intranet, an extranet, a VPN, an LAN, a WLAN, a WAN, a WWAN, an MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 380 or a portion of the network 380 may include a wireless or cellular network, and the coupling 382 may be a Code Division Multiple Access (CDMA) connection, a Global System for Mobile communications (GSM) connection, or another type of cellular or wireless coupling. In this example, the coupling 382 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 316 may be transmitted or received over the network 380 using a transmission medium via a network interface device (e.g., a network interface component included in the communication components 364) and utilizing any one of a number of well-known transfer protocols (e.g., hypertext transfer protocol (HTTP)). Similarly, the instructions 316 may be transmitted or received using a transmission medium via the coupling 372 (e.g., a peer-to-peer coupling) to the devices 370. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 316 for execution by the machine 300, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

FIG. 4 illustrates an example user interface 400 (e.g., a mobile application user interface, a web browser user interface) for viewing and/or managing wish lists of properties, according to some embodiments. In this example, a user is shown previews of wish lists of properties in an online marketplace. The example shows previews of wish lists, including a wish list for LA trips 402, a wish list for Seattle, WA, USA 404, a wish list for Yosemite National Park, California, United States 406, a wish list for Los Angeles 408, a wish list for Hi (for Hawaii) 410, a wish list for Apulia, Italy 412, a wish list for Rome, Italy 2023 414, a wish list for Chemuyil, Mexico 416, and a wish list for Washington, United States 418.

The wish lists may be created in prior uses of the online marketplace. A user may use the online marketplace during several sessions and/or using different modalities. For example, a user may use the website using a mobile phone in the morning, create wish lists during a session. The user may later continue the triaging process, using the website on a desktop, during another session. During the subsequent session, the user may continue adding to and/or updating the wish list. The wish list management module 150 may include session management for handling sessions, and/or device management to process inputs from different types of devices. The visualization module 142 may generate types of visualizations for the wish lists depending on which device the user may be using, and/or user preferences, preferences of other users, and/or historical usage information.

Different users may create such wish lists. For example, a couple planning a trip may initially choose to shortlist properties for the trip independently, exchange the initial list, then collaborate during subsequent triage of the properties. The wish lists may be merged when exchanged, and/or different copies may be stored by the wish list management module 150, with appropriate annotations (e.g., wish list 1 is created by current user, wish list 2 is received from another user, wish list 3 is merged with another wish list). Furthermore, the wish lists may be created during different time zones, and/or different devices and/or modalities. The wish list management module 150 may automatically adjust the wish lists (e.g., date, time zone, device identifiers) according to the origin of the wish lists and history of the wish lists. Recently created wish lists may be shown in the interface as a preview. After a user creates different wish lists, more recent wish lists may be prioritized and shown to the user as previews. Some wish lists may be previewed (e.g., properties, property images, and/or property cards from some wish list may be shown), while other wish lists may be hidden. The wish lists need not be limited to geographic locations or areas, and/or multiple wish lists may be created for a same area. For example, a wish list may be based on attributes or features of properties, such as size, number of bedrooms, accessibility, cost, and similar factors. The user may create several wish lists for an area. The wish lists may be named similarly, previews of properties (e.g., thumbnail images) may help differentiate the properties in the wish lists, even if the wish lists are named similarly.

The order of the wish lists shown in the interface may be determined based on a variety of factors, including user preferences, user behaviors (e.g., interactions with the online marketplace), and/or preferences of other similar users. The example also shows that each wish list may be previewed using a collage of images for properties in the wish list. The system may use various methods for selecting images, including thumbnail images, enlarged views, and/or trimmed views, for each collage. In this example, a primary image is shown along with two other images. For example, the wish list for LA trip 402 is previewed using a primary image 420 and two smaller images 422 and 424. The primary image is larger than the other two images. Various other configurations are possible, including varying number of images for a preview of a wish list and/or different image configurations for different wish lists.

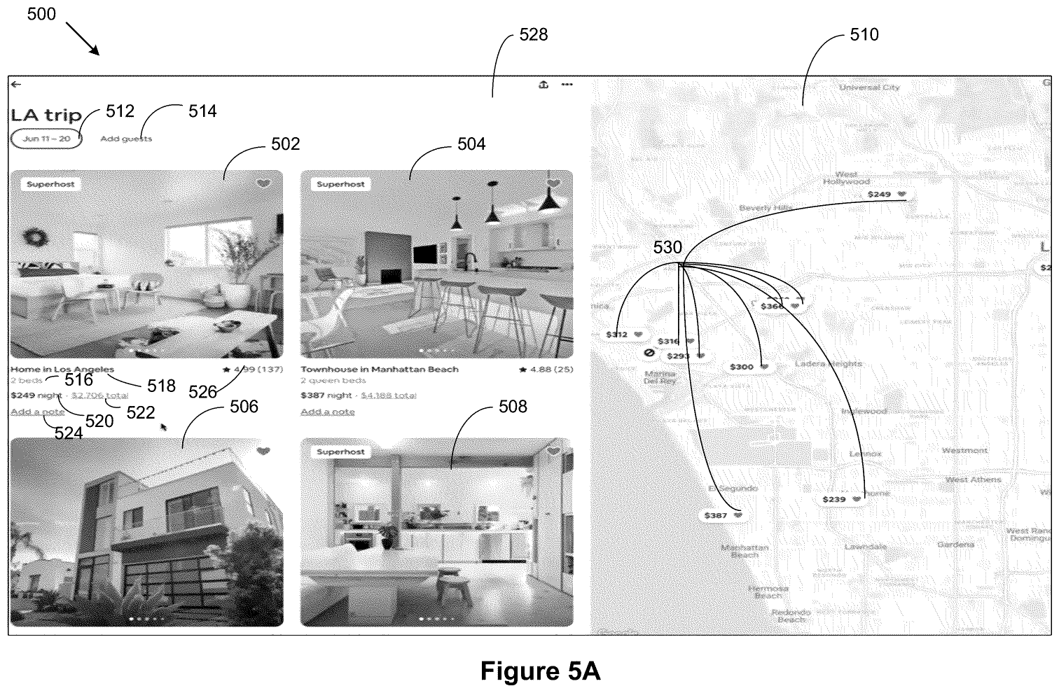

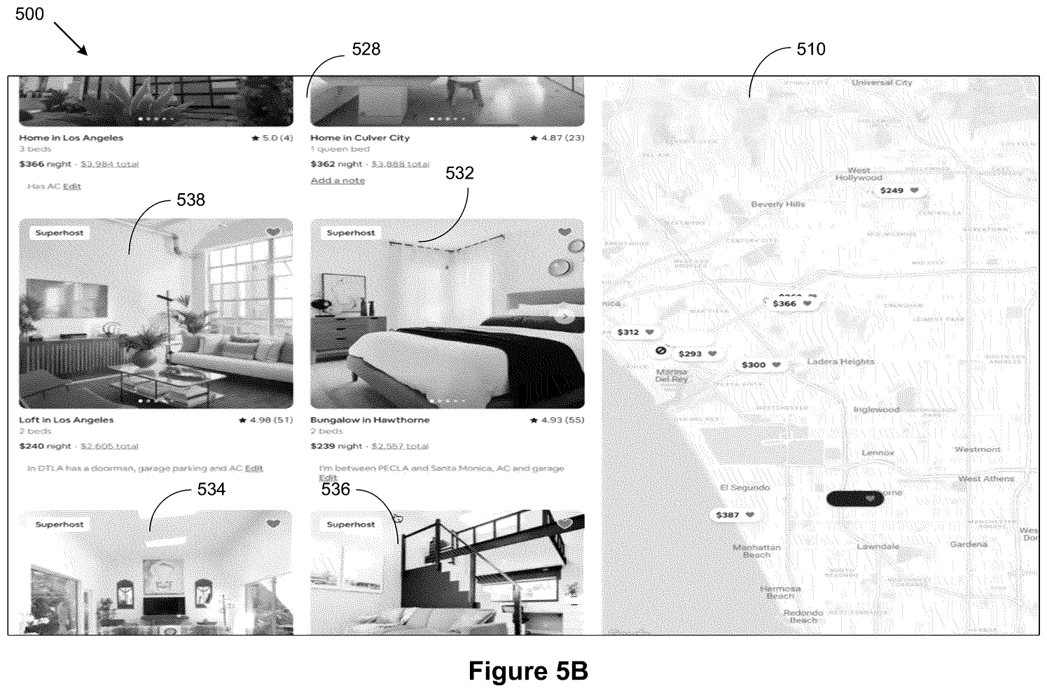

FIG. 5A illustrates an example user interface 500 (e.g., a mobile application user interface, a web browser user interface) for viewing and/or managing a wish list of properties, for adding notes to wish lists according to some embodiments. The example shows a wish list for LA trip. When a user selects a wish list (e.g., a wish list shown in the example described above in reference to FIG. 4), the graphical user interface is updated to show a list of property cards for properties in the wish list. In this example, four property cards 502, 504, 506, and 508, for the wish list, are previewed. Each property card may include an image or a thumbnail image of a view of the property, and/or information on the property (e.g., a name, notes, cost). The view may be selected based on various factors, including appeal of the view, user preferences, preferences of other users, and/or usage history. Due to limited screen size or form factors of devices (e.g., a mobile device may have a smaller screen area compared to a desktop application), a subset of the properties in the wish list may be previewed. The number of properties previewed may be based on a variety of factors, including user preferences, preferences of other users, history of usages, and/or recency of data. Summary and/or various features of each property listing may be shown as part of each property card. For example, the preview 502 includes a title 518 (“Home in Los Angeles”), a number of beds 516 (“2 beds”), a cost 520 (“$249”), a total cost 522 (“$2,206 total”), and a rating 526. A subset or a superset of these features may be shown in each property card. Furthermore, different number of features may be shown or highlighted in each property card. The total cost may be based on selected dates for the wish list. The user may select and/or adjust dates for the wish list using an affordance 512. The user may also add guests to the property using another affordance 514, for the wish list.

Each property card may also include an affordance for adding a note to the property. For example, FIG. 5 shows an affordance 524 for adding a note. Where notes are previously added by a user, such notes may be shown and/or previewed in each property card. Some embodiments show a map (e.g., map 510) alongside the preview of properties. The map may be selected based on regions or locations of properties in the wish list. The map may indicate approximate locations of all or a subset of the properties (e.g., properties previewed in another region 528 of the user interface) in the wish lists using pins. In the example shown, properties in the LA trip wish list are indicated by markers 530. The markers may include cost information and/or icon(s) to indicate that the properties are part of the wish list.

FIG. 5B shows another view of the example user interface 500, according to some embodiments. The region 528 is updated after the user scrolls down the wish list. New property cards (e.g., property cards 532, 534, 536, and 538) may be shown. The map 510 may also be updated accordingly. For example, the map may be adjusted to show the properties in the new property cards.

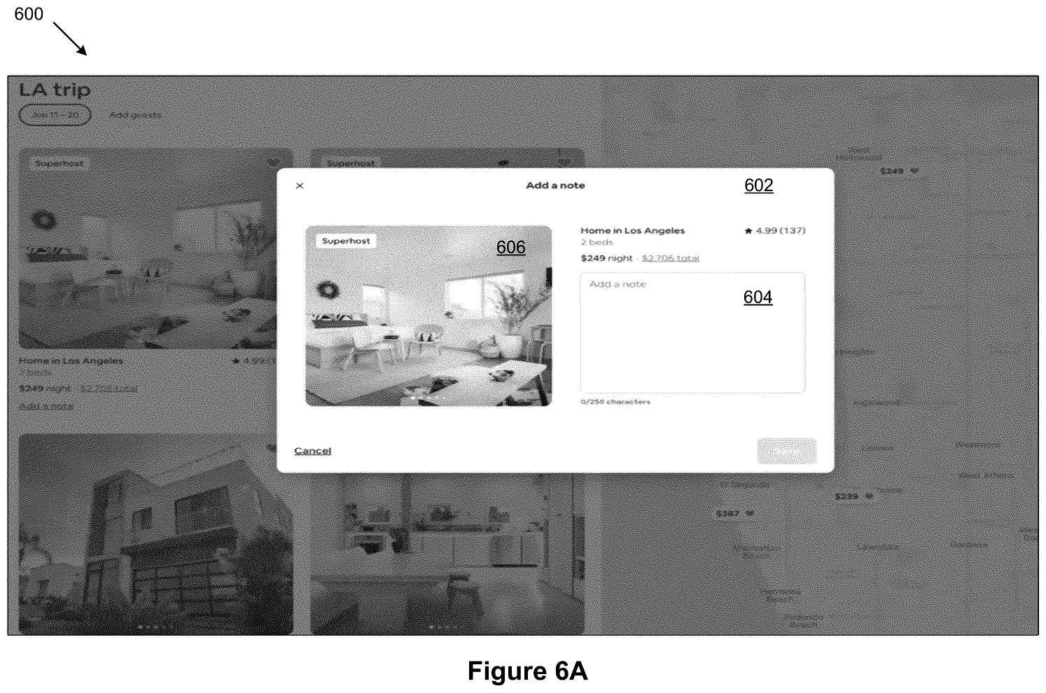

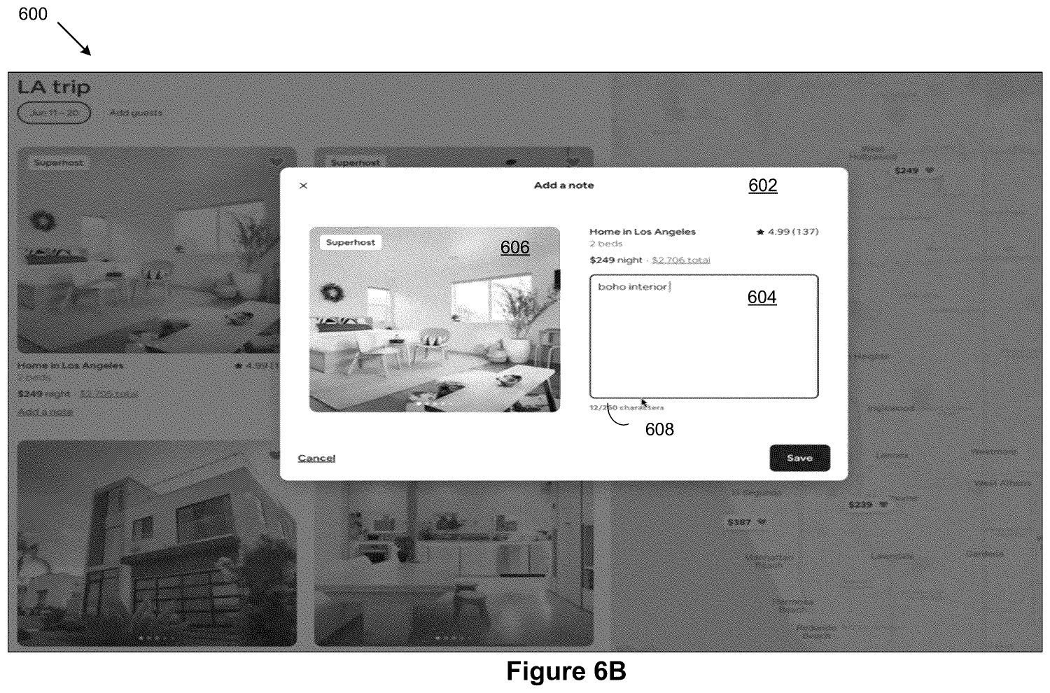

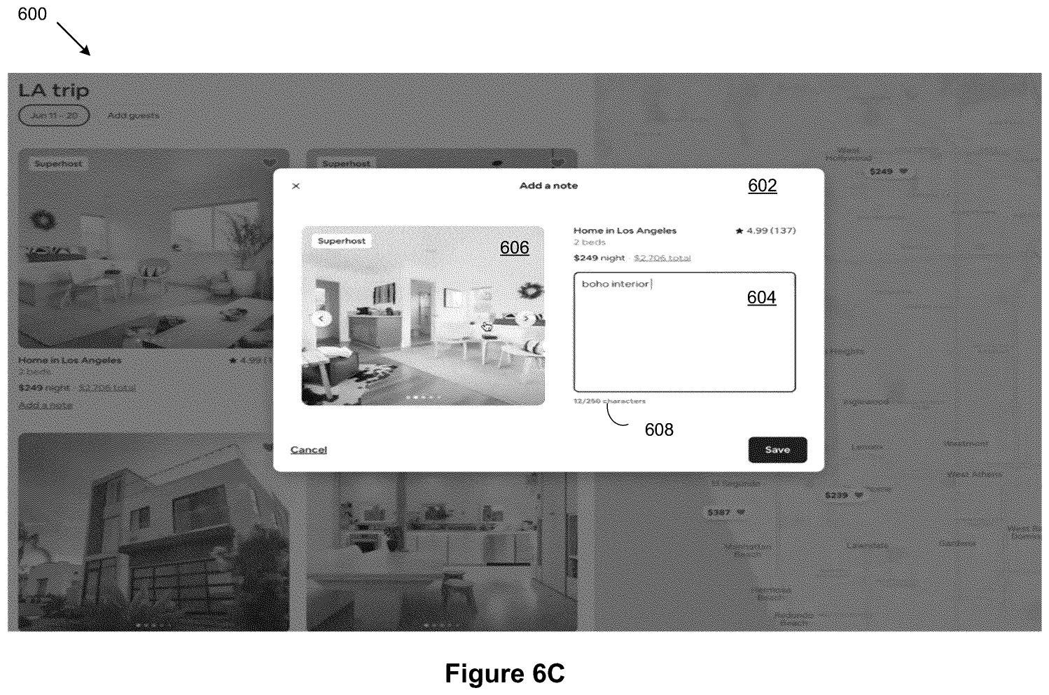

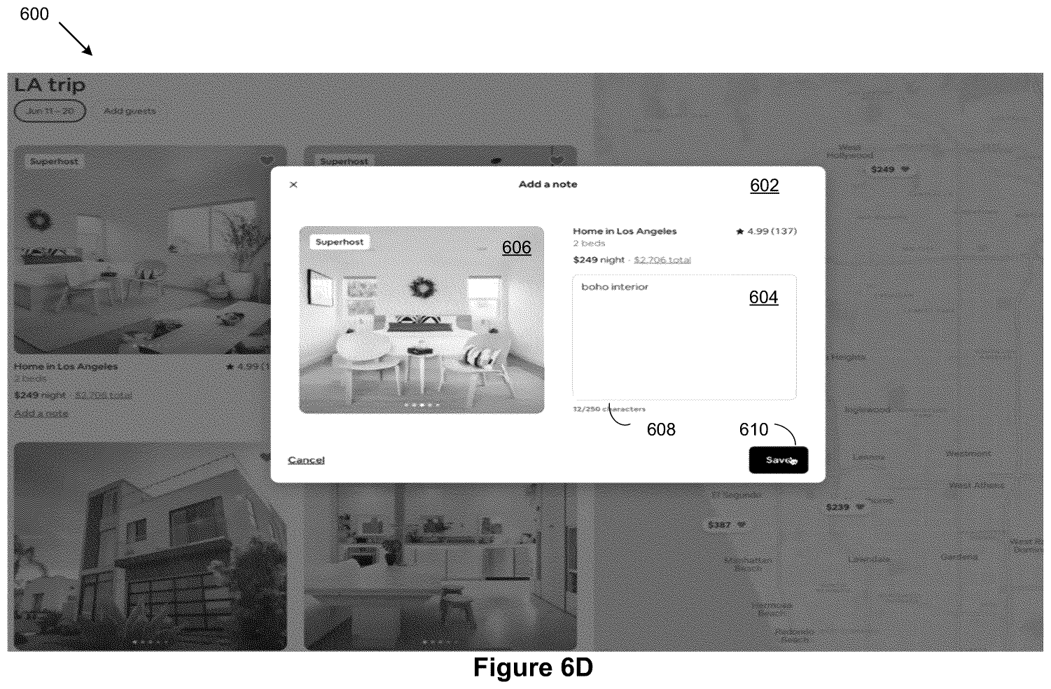

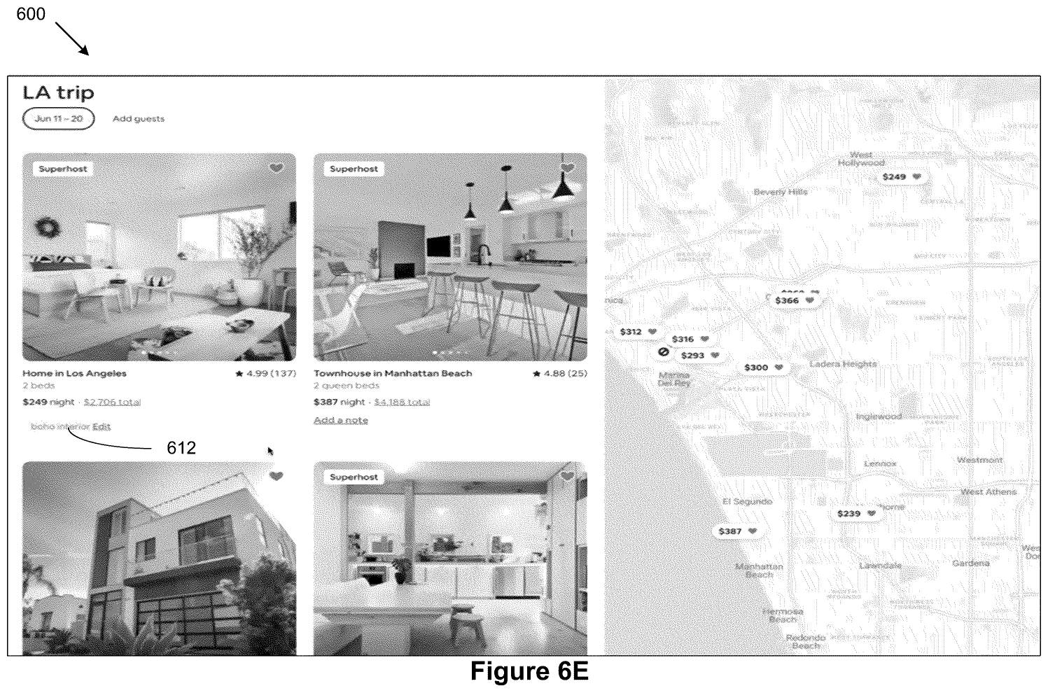

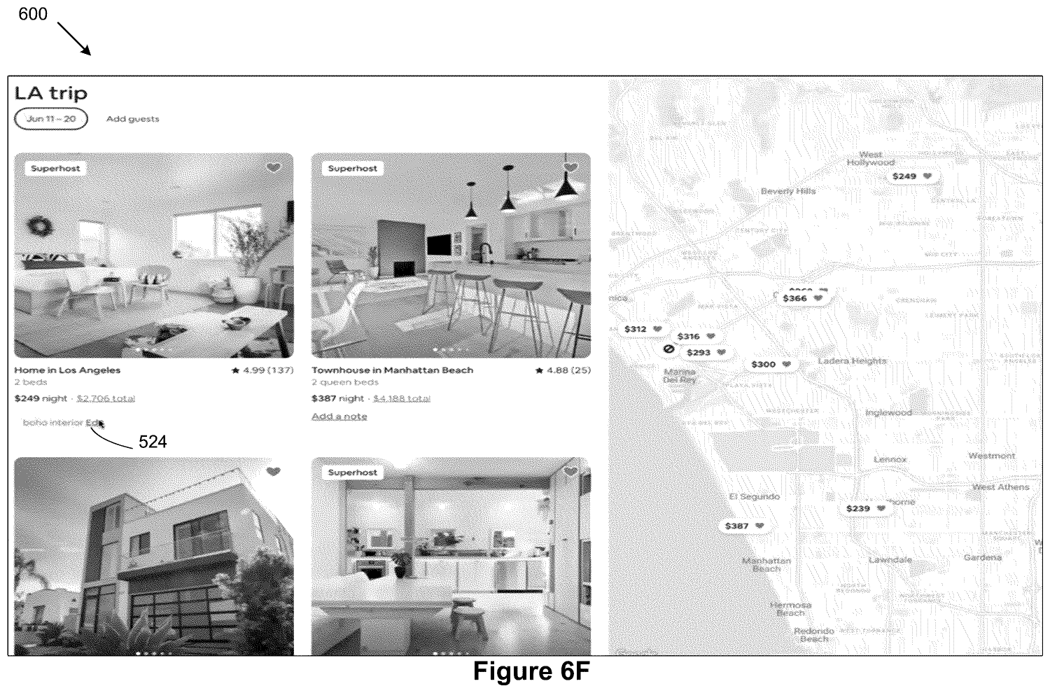

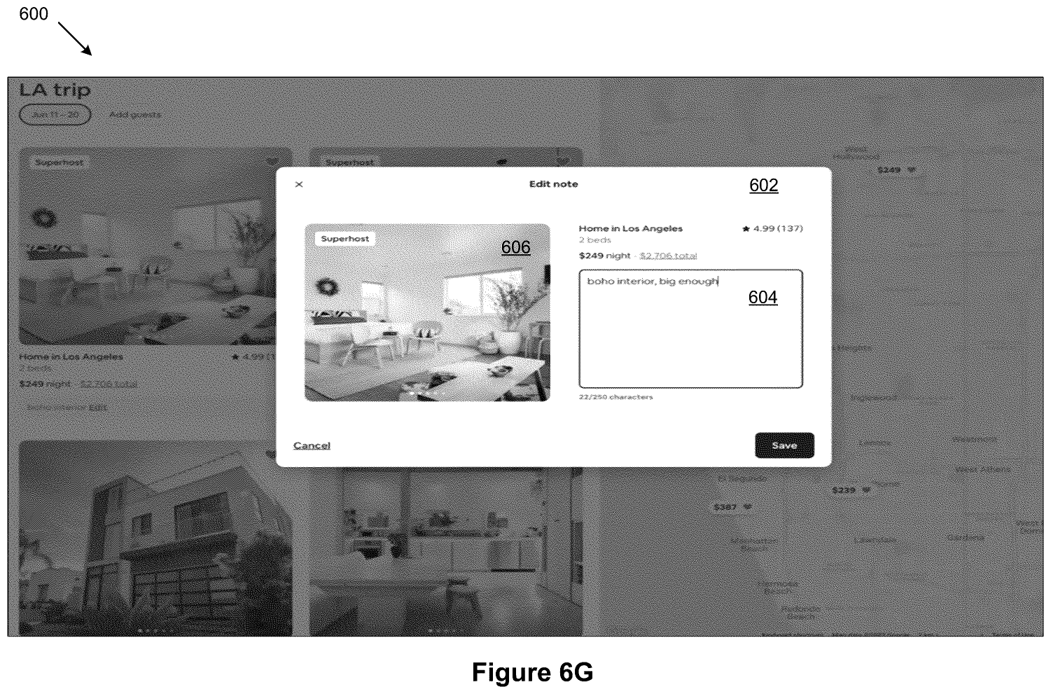

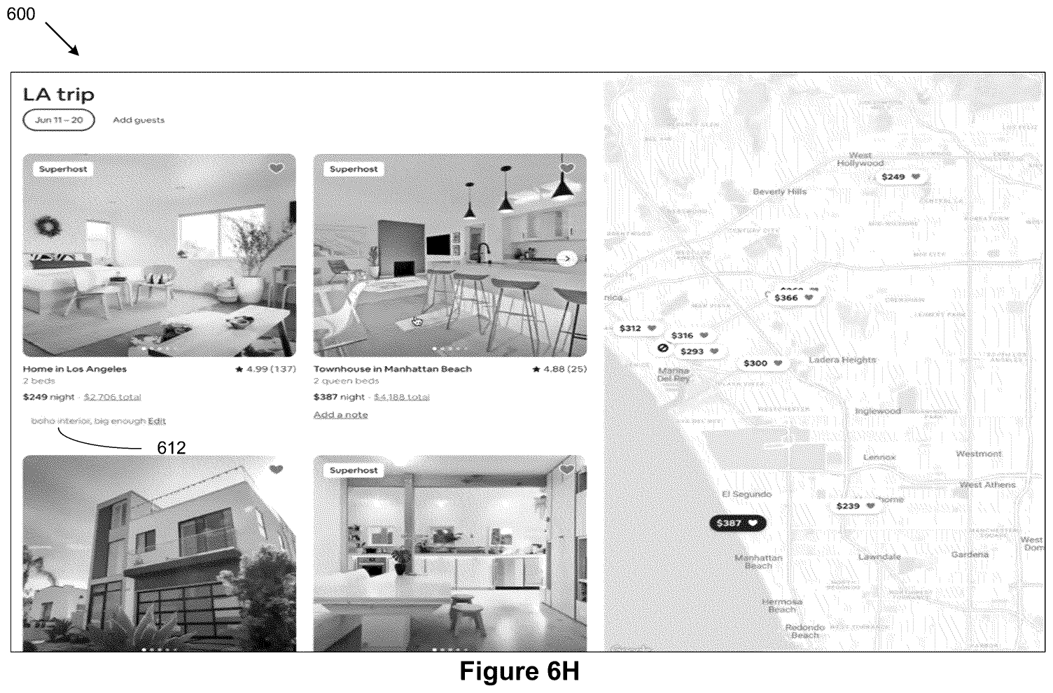

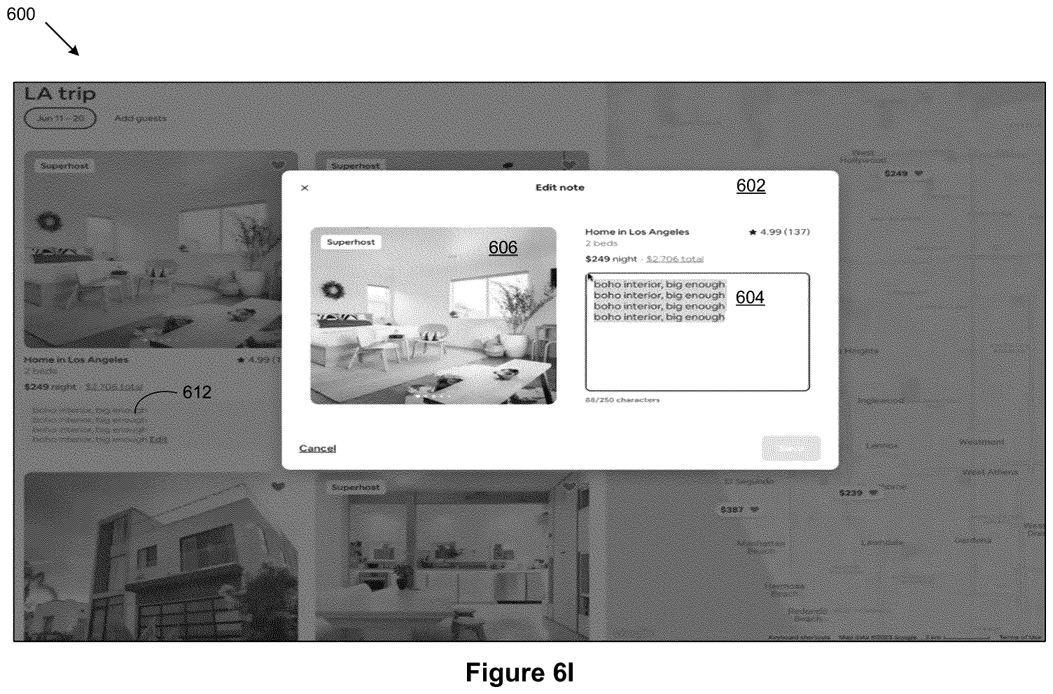

FIG. 6A illustrates an example user interface 600 (e.g., a mobile application user interface, a web browser user interface) for adding a note for a property of wish list, according to some embodiments. After a user selects an affordance (e.g., the affordance 524 of FIG. 5A) to add a note to a property in a wish list, a wish list pop-up (e.g., an overlap pop-up 602 of FIG. 6A) may be shown. The pop-up may allow a user to add a note for the property. The pop-up may provide focused information on the property (e.g., information shown in the property card for the property may be enlarged and shown), along with a text box (e.g., box 604) to enter notes. Some embodiments allow a maximum number of characters (or words) (e.g., 250 characters) for notes for a property. A region 606 in the pop-up may show a thumbnail image of a view of the property.

FIG. 6B shows another view of the example user interface 600 after a user starts typing a text to add notes for a property listing, according to some embodiments. In this example, the user types “Boho interior” in the text box 604. Some embodiments update the number of characters 608 (e.g., 12/250 characters) to indicate the amount of text entered by the user and how close they may be to a limit.

FIG. 6C shows another view of the example user interface 600 after a user selects a different image or view for the property listing, according to some embodiments. In some embodiments, the user can interact with the images (e.g., select other images or views of the property to preview in the region 606). The user may look at different views of the property while adding notes for a property, to inform their choice for the notes.

FIG. 6D shows another view of the example user interface 600 after a user selects a different image or view for the property listing, according to some embodiments. The user may save the notes (e.g., by clicking an affordance 610) in the pop-up overlay 602.

FIG. 6E shows another view of the example user interface 600 after a user saves a note for a property listing of a wish list, according to some embodiments. In this example, suppose the user saves the text “Boho interior” for the Home in Los Angeles. The text may show up as a note 612 in the property card. The note may be associated with the corresponding property in the wish list for the user.

FIG. 6F shows another view of the example user interface 600 for property listings of a wish list, according to some embodiments. The user may select the affordance 524 to further edit, modify, and/or delete the note added for the property listing.

FIG. 6G shows another view of the example user interface 600 for property listings of a wish list, according to some embodiments. The user may add more text as notes for the property listing in the text box 604. In this example, the user adds the text “, big enough” to the notes.

FIG. 6H shows another view of the example user interface 600 after the user saves the additional note for the property listing of a wish list, according to some embodiments. The updated text may show up as the note 612 in the property card for the property listing. The updated note may be associated with the corresponding property in the wish list for the user.

FIG. 6I shows another view of the example user interface 600 after the user enters additional text for notes for the property listing of a wish list, according to some embodiments. In some embodiments, the text entered may be replicated (e.g., the notes entered in the region 604 is replicated in the property card for the property listing). In some embodiments, a summary of the text entered by the user may be shown in the property card. If text is repeated, a single instance of the text may be shown. Displaying notes alongside the properties enables the user to quickly note any prior comments on the property, and helps with faster triage of the properties.

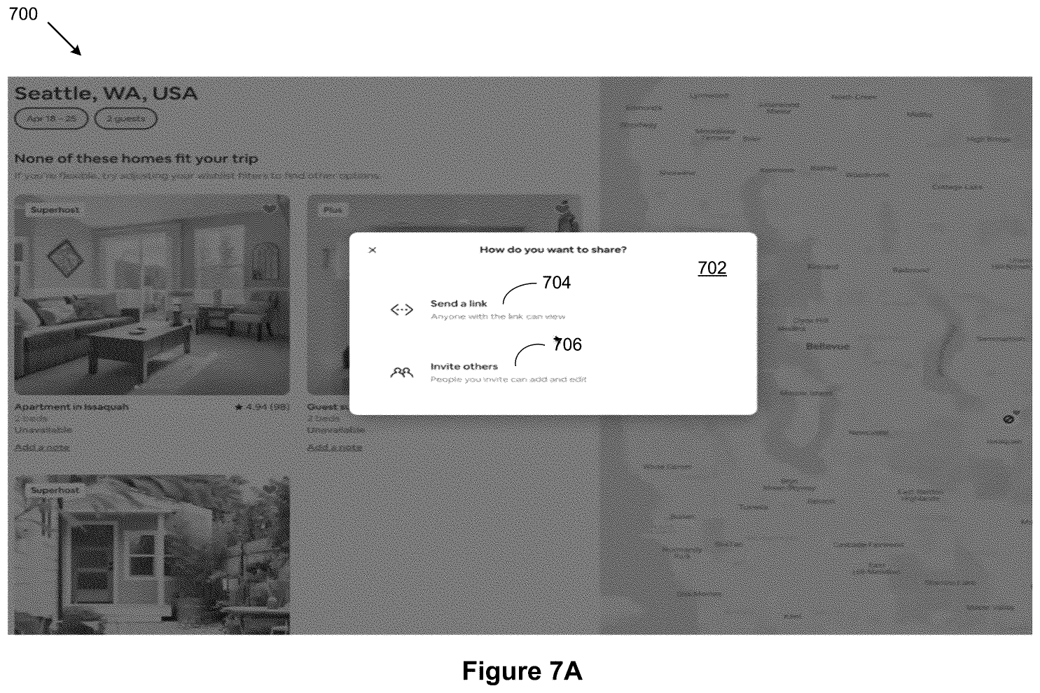

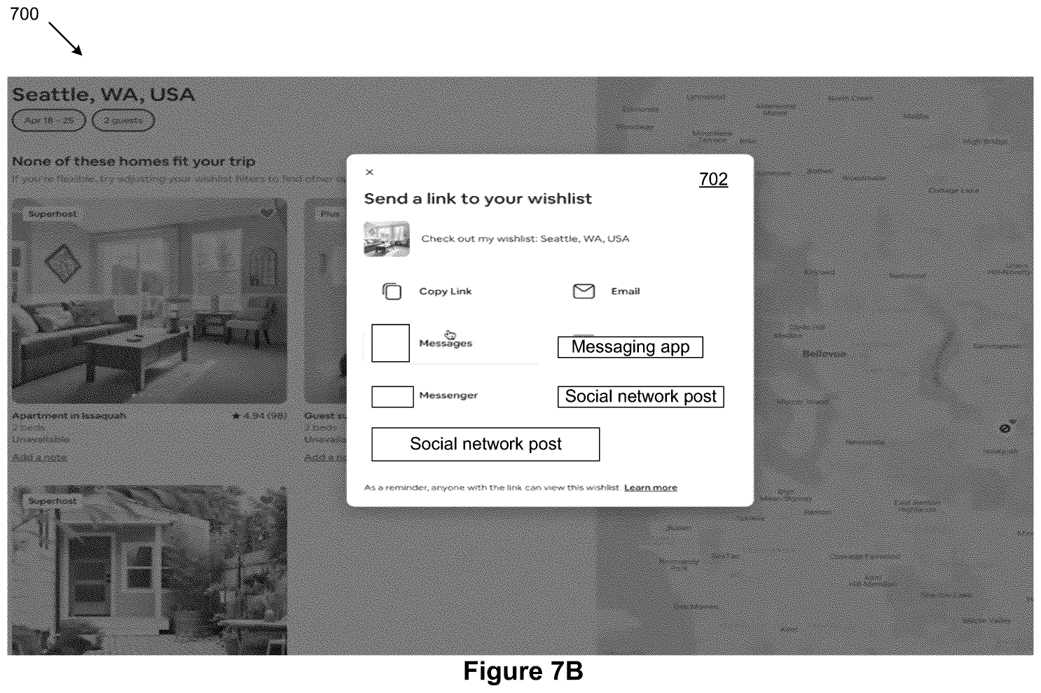

FIG. 7A illustrates an example user interface 700 (e.g., a mobile application user interface, a web browser user interface) for sharing a wish list, according to some embodiments. In some embodiments, the system may show a share wish list overlay (e.g., a pop-up overlap 702) for sharing a wish list. A user may be provided options to share the link. For example, an affordance 704 may allow the user to send a link to the wish list to any other users; users that receive the link may then view the wish list of the user. Another affordance 706 may allow the user to invite others; other users who are invited may add and/or edit properties, including notes added to such properties.

FIG. 7B shows another view of the example user interface 700 after a user selects to share a link to a wish list, according to some embodiments. In some embodiments, the system may update the share wish list overlay 702 with various options for sending the link (e.g., copy link, email the link, message using a messaging application, post a note to a social network).

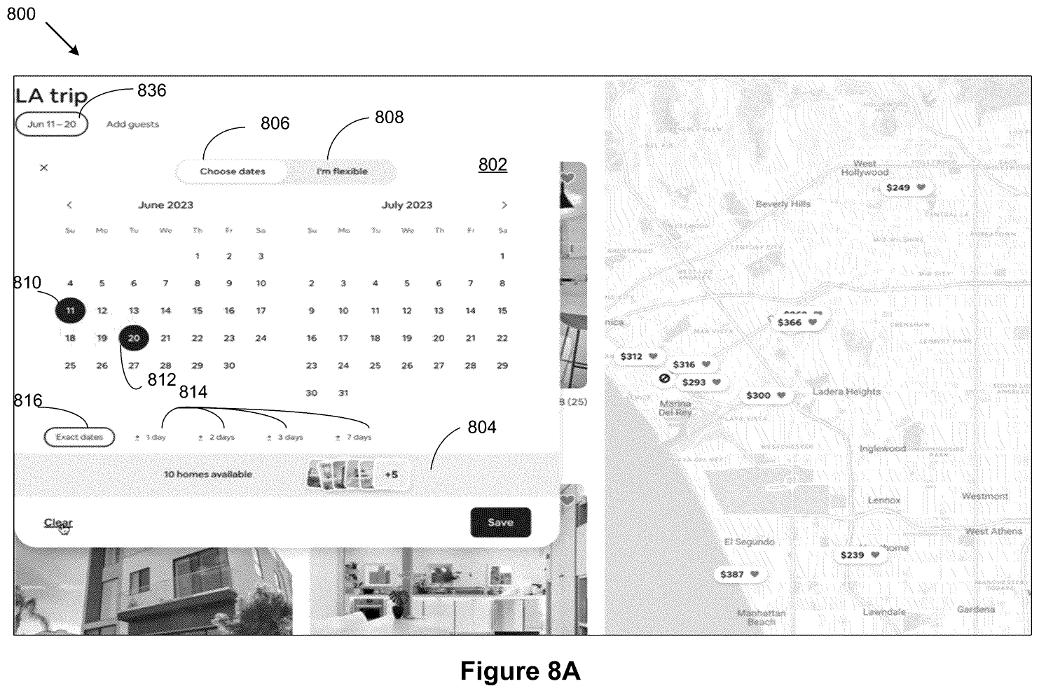

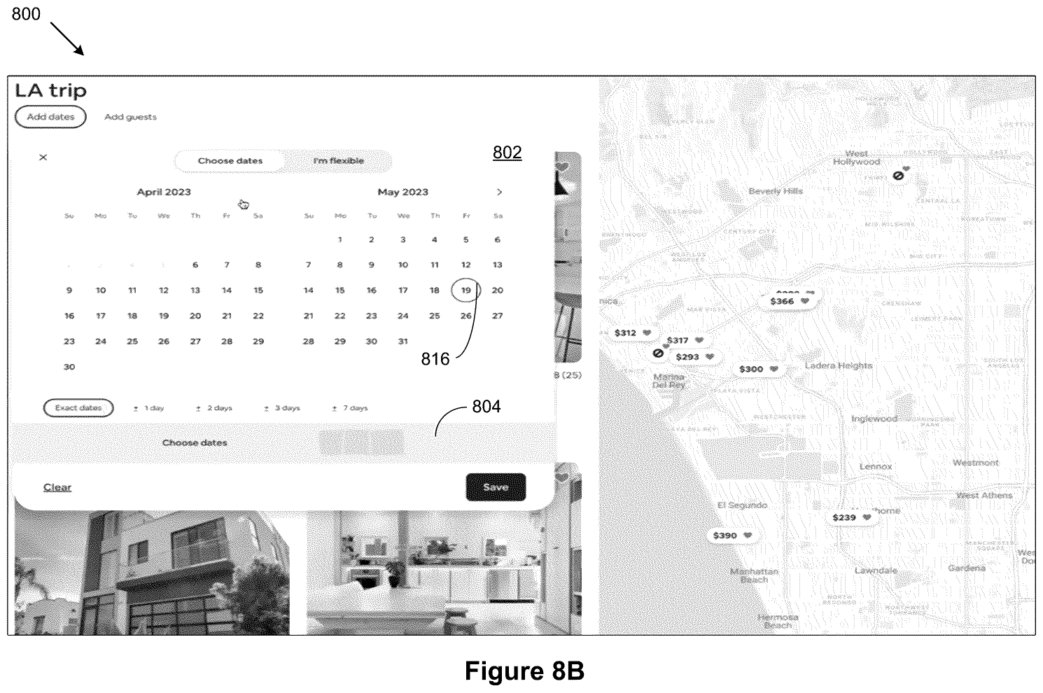

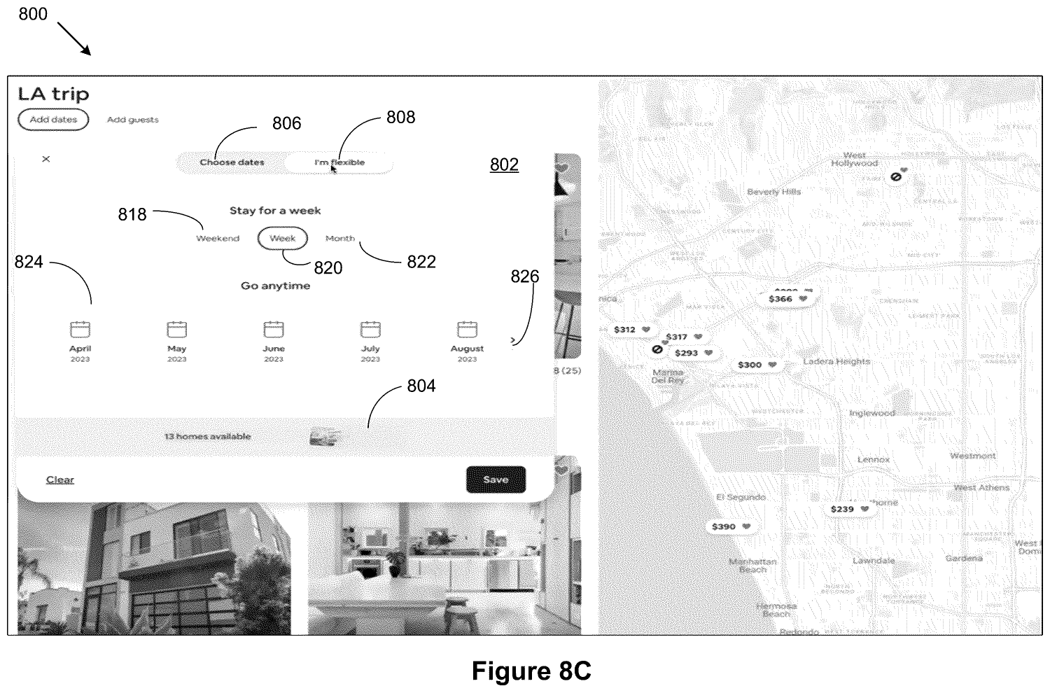

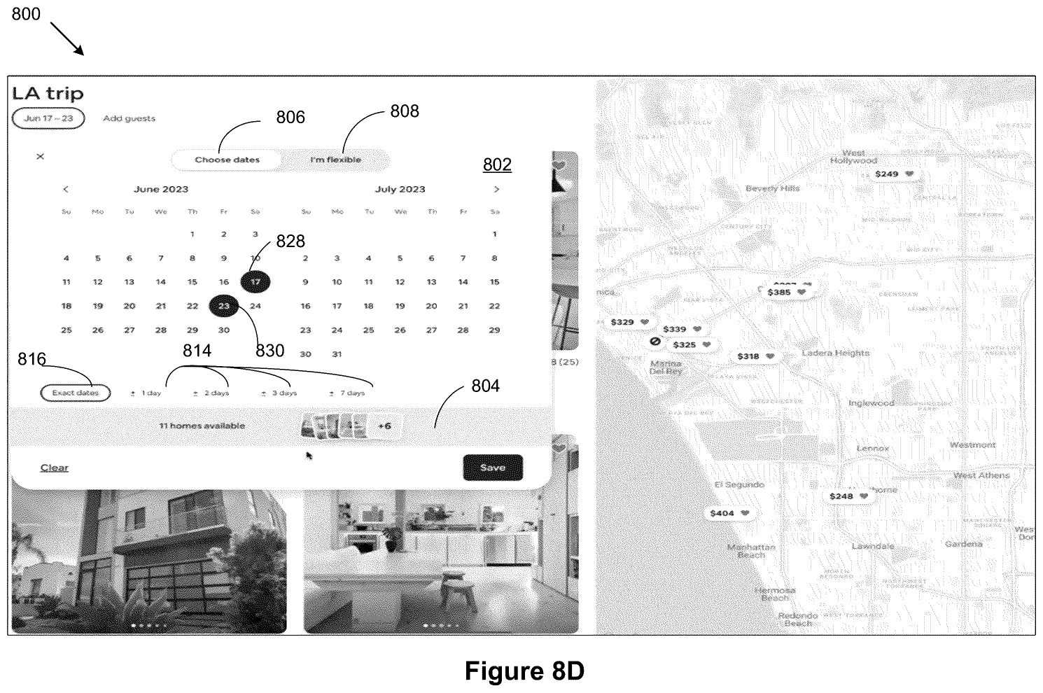

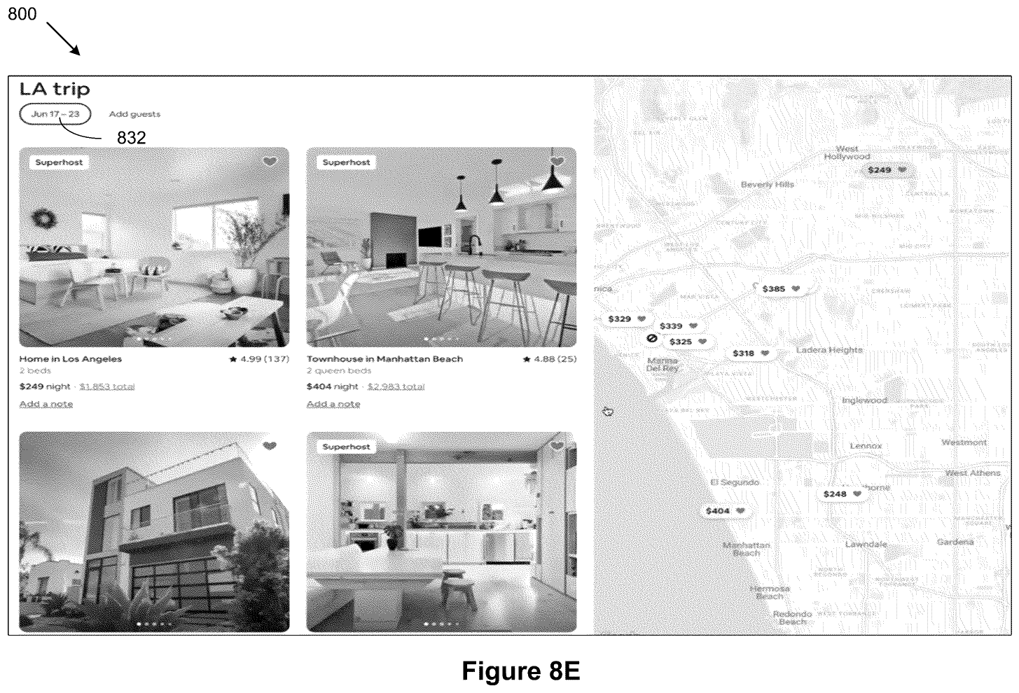

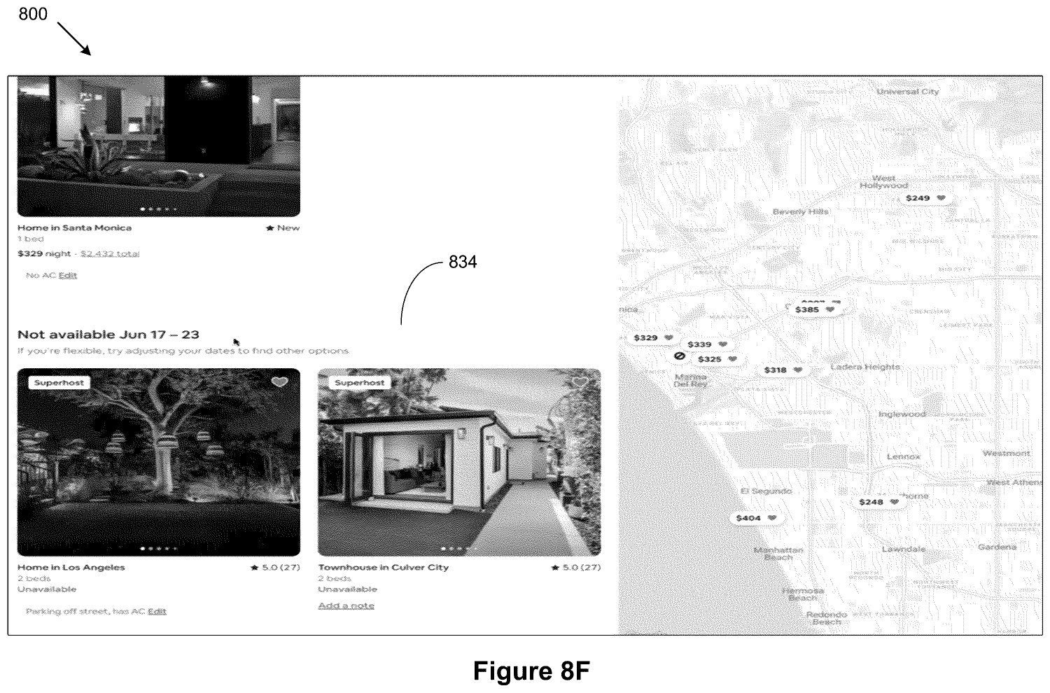

FIG. 8A illustrates an example user interface 800 (e.g., a mobile application user interface, a web browser user interface) for selecting dates for properties in a wish list and/or filtering properties in a wish list by date, according to some embodiments. The example shows an overlay 802 that allows a user to choose dates 806, using a calendar. In this example, the user has selected a start date 810 of Jun. 11, 2023, and an end date 812 of Jun. 20, 2023. Also shown are affordances for exact dates 816, dates with leeway 814 (e.g., +/−1 day, +/−2 days, +/−3 days, and +/−7 days). The user may also choose another option 808 if they are flexible about the dates. A region 804 in the overlay 802 may show a preview (e.g., thumbnail images) of properties available during the dates selected.

FIG. 8B shows another view of the example user interface 800 after the user selects a different start date 816, according to some embodiments. The preview 804 shown in FIG. 8A may be updated when or after a new date is selected.

FIG. 8C shows another view of the example user interface 800 for flexible dates, according to some embodiments. When a user selects an option 808 for flexible dates, the overlay 802 may be updated to show options for the stay (e.g., weekend 818, week 820, month 822), a range of months 824 to go anytime. In some embodiments, the user may choose a different set of months by selecting an affordance 826. The region 804 may be updated in real-time accordingly. For example, new thumbnail images may be generated and/or stacked along with older thumbnail images. Having the region 804 updated in real-time helps with faster triage. For example, when a user shifts dates, the user is immediately notified about what properties are available during the dates. The thumbnail images may provide a preview of the images, so the stack of thumbnail images may indicate preferred properties on top of the stack so that the user can quickly view the properties of interest for selected dates. Some embodiments may update the wish list management interface and/or the map in real-time.

FIG. 8D shows another view of the example user interface 800 after the user selects different dates, according to some embodiments. The example shows the user selecting a new start date 828 (June 17^{th}) and a new end date 830 (June 23^{rd}) and the region 804 being updated automatically for the new dates.

FIG. 8E shows another view of the example user interface 800 after the user has selected dates for the wish list, according to some embodiments. The interface shows an indication 832 for the dates selected followed by properties available during the selected dates.

FIG. 8F shows another view of the example user interface 800 that shows properties in the wish list that are unavailable, according to some embodiments. Some embodiments may show the unavailable properties in a different region or a different portion 834 of the user interface. In some embodiments, available listings are followed by unavailable listings. The user may scroll down to see the listings.

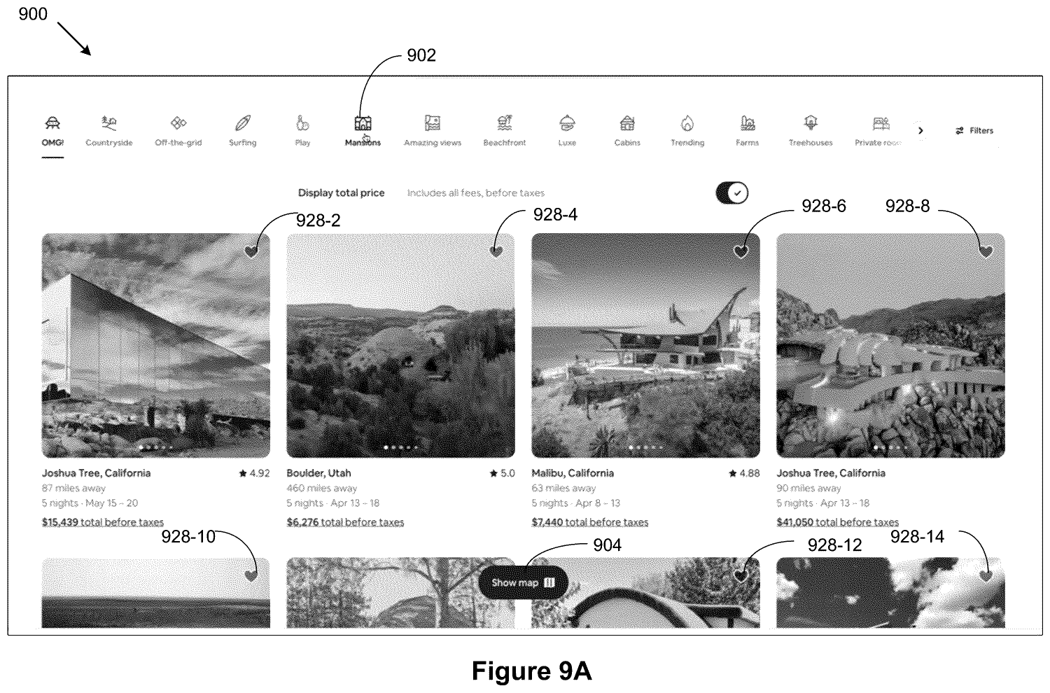

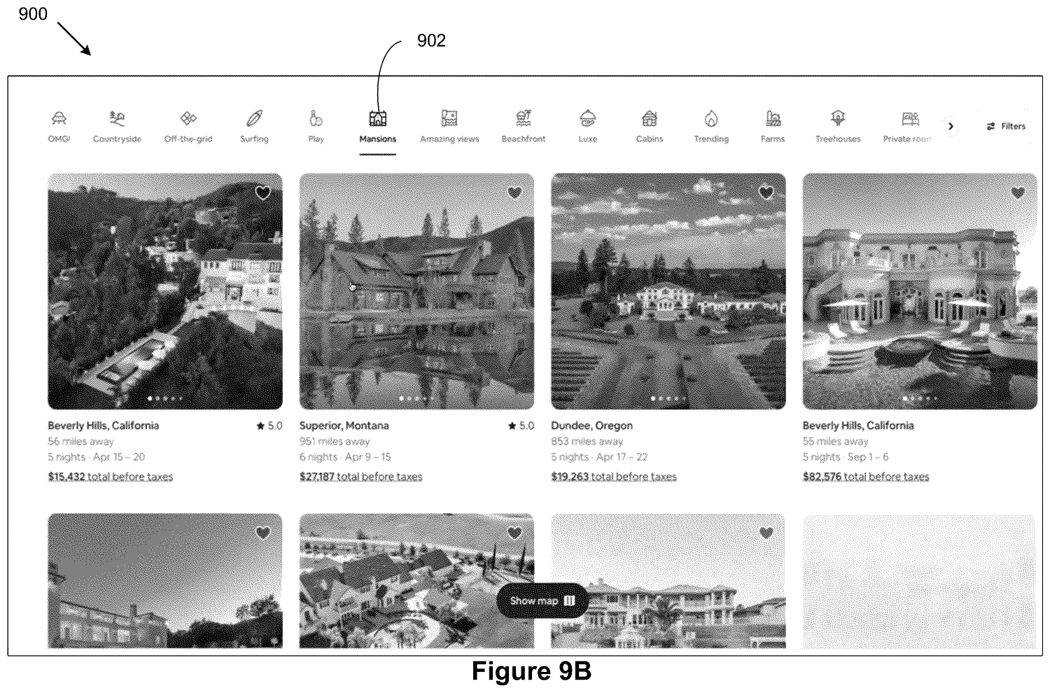

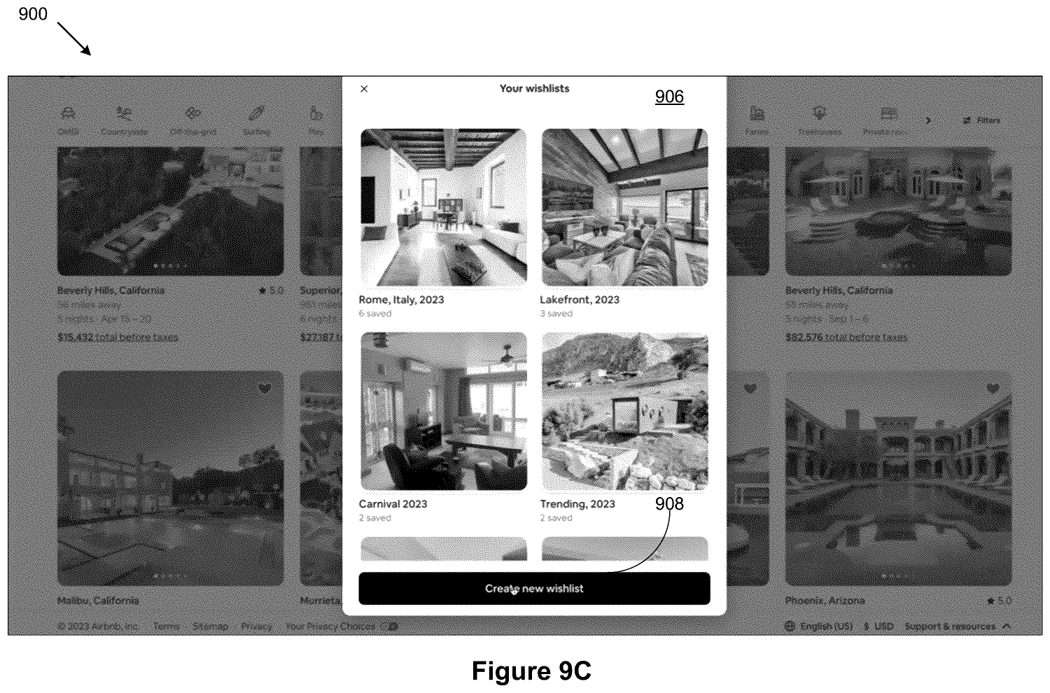

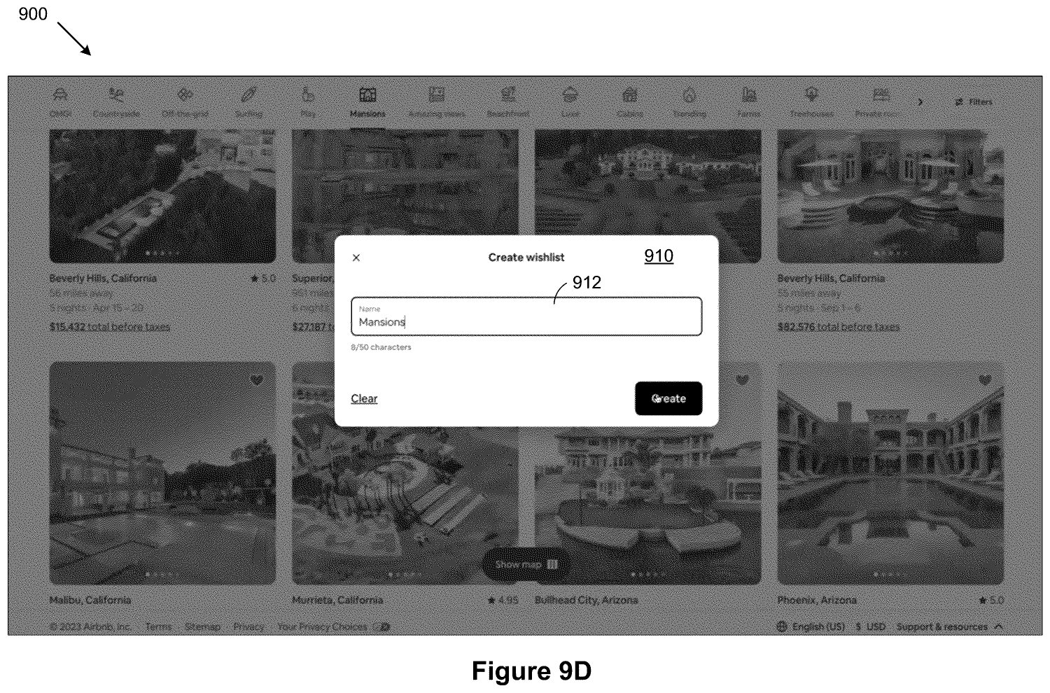

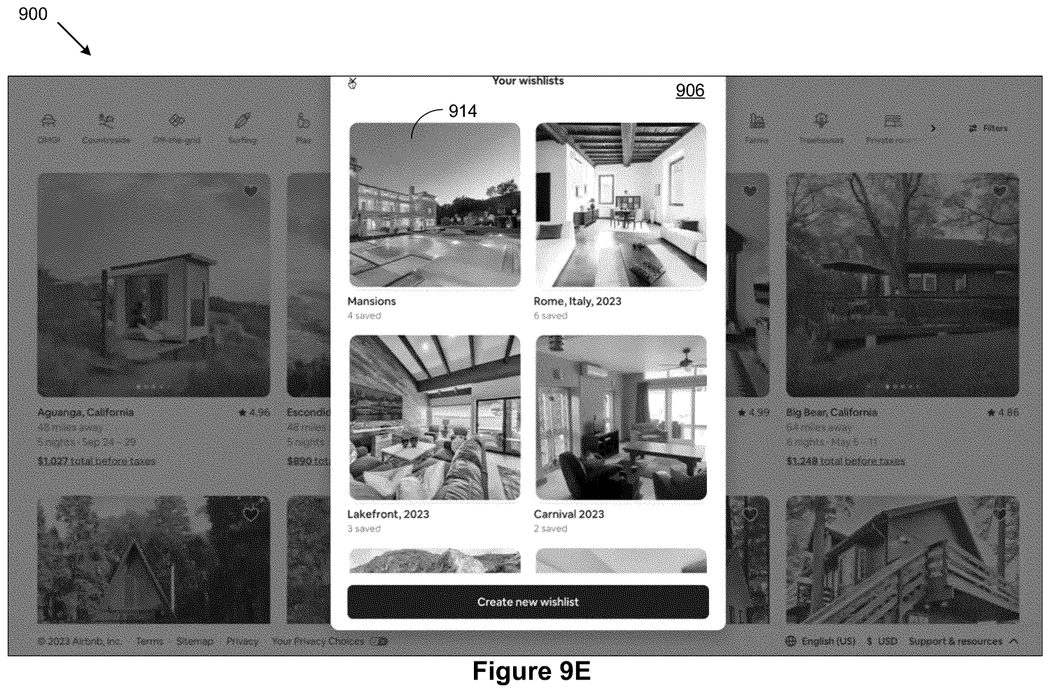

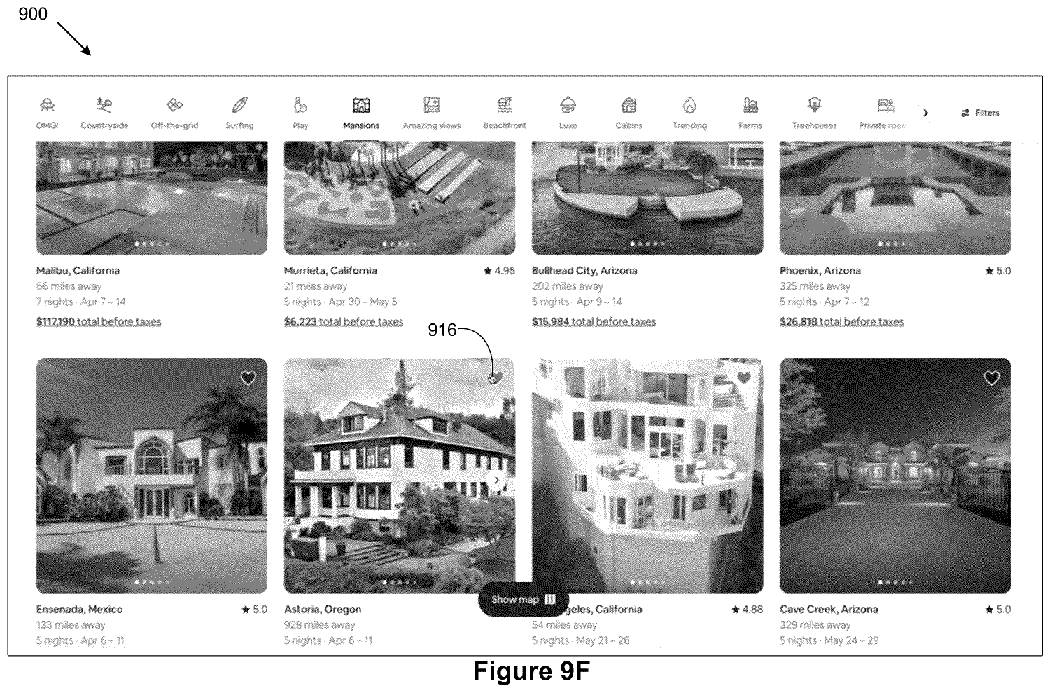

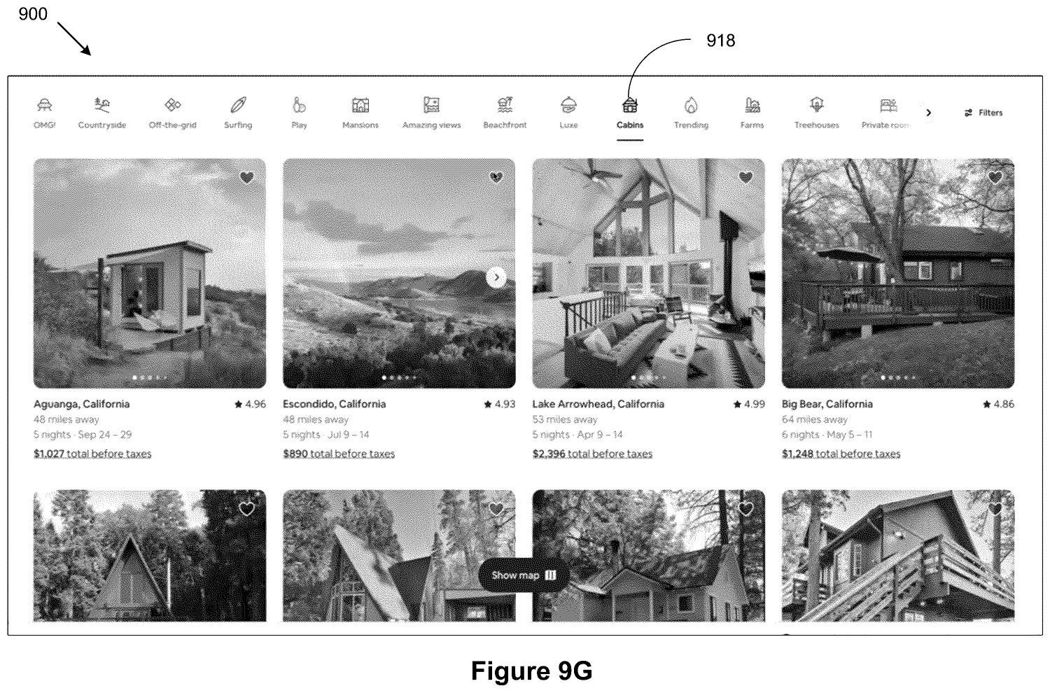

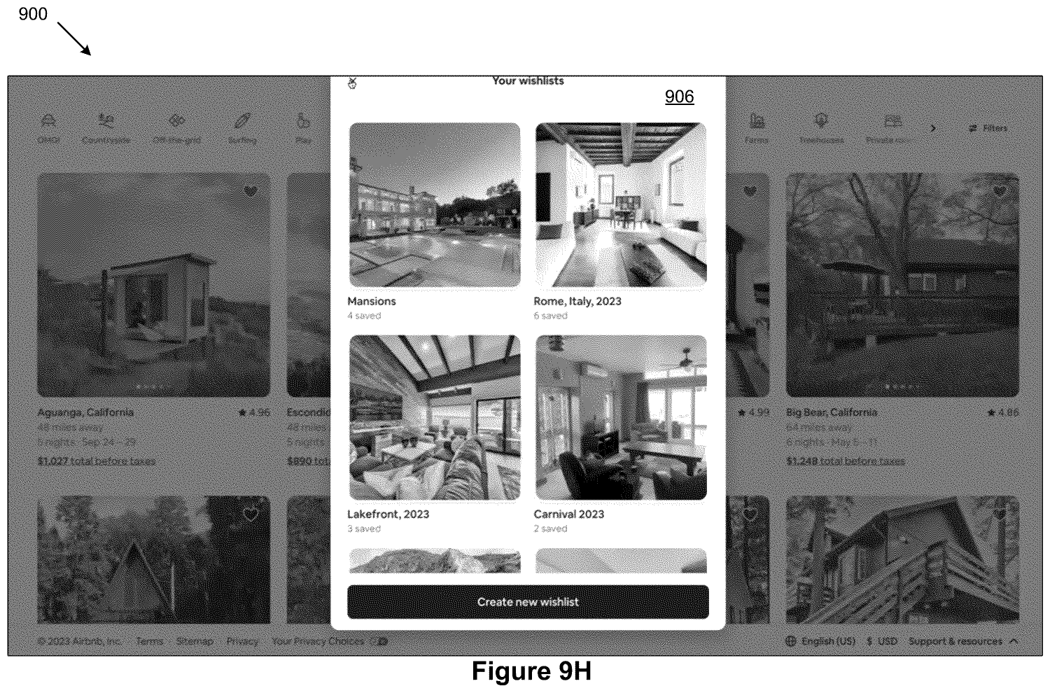

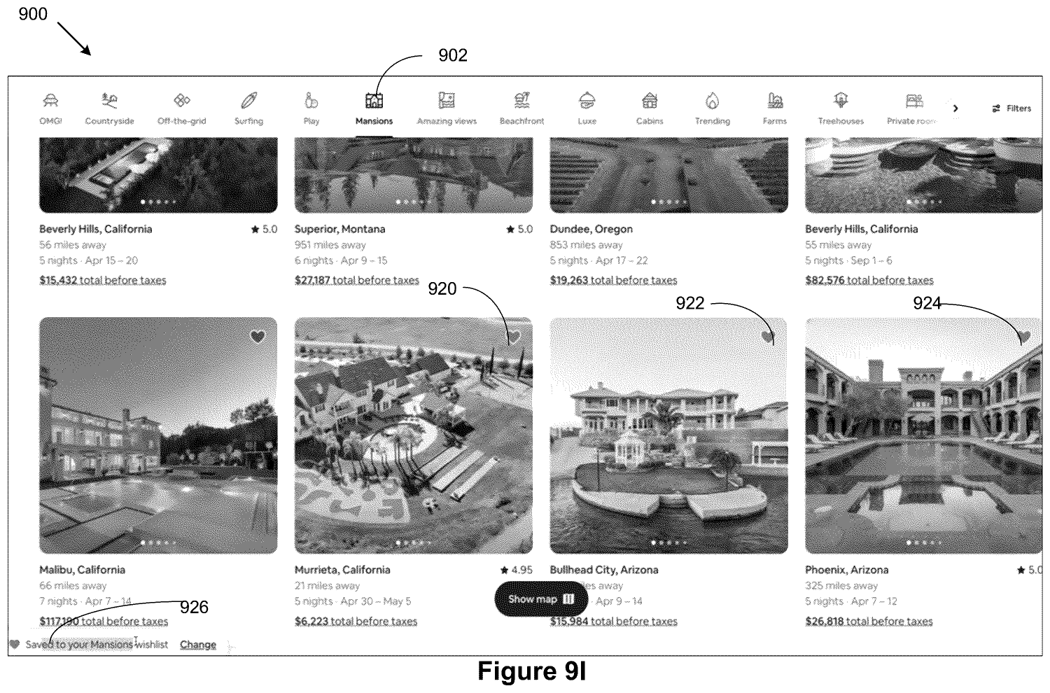

FIG. 9A illustrates an example user interface 900 (e.g., a mobile application user interface, a web browser user interface) for easy saves to wish lists, according to some embodiments. The example shows various categories of properties (or properties with different attributes). In this example, the categories shown are OMG!, Countryside, Off-the-grid, Surfing, Play, Mansions, amazing views, Beachfront, Luxe, Cabins, Trending, Farms, Treehouses, and Private rooms. Suppose a user selects the Mansions category 902. The user interface may be updated to show mansions available in the online marketplace. Some embodiments provide an option 904 for the user to select to show a map for the properties in the category. A wish list may be a collection of data stored on a database (e.g., the memory of the application server 140) including a listing of one or more unique identifiers associated with products and/or services offered for sale at an online marketplace.

FIG. 9B shows another view of the example user interface 900 that shows properties corresponding to the mansions category 902, in response to a user selection of the mansions category 902 as shown in FIG. 9A, according to some embodiments. The user may look at these properties by scrolling down the listings for the category.

FIG. 9C shows another view of the example user interface 900 after the user has selected to view wish lists, according to some embodiments. An overlay 906 shows wish lists for the user. The overlay may include an option 908 to create a new wish list.

FIG. 9D shows another view of the example user interface 900 after the user has selected to create a new wish list, according to some embodiments. An overlay 910 may provide a text box 912 to name the wish list. The name may be pre-populated with the name of the category (Mansions, in this case). The user can override or provide a new name for the wish list.

FIG. 9E shows another view of the example user interface 900 after the user has selected to view wish lists, according to some embodiments. The overlay 906 shows wish lists for the user, including the new wish list for Mansions 916. The system may choose representative images for the wish lists depending on various factors, including user preferences, preferences of other users, and/or history of interactions of the user with the online marketplace.

FIG. 9F shows another view of the example user interface 900 after the user has selected to view a wish list, according to some embodiments. In this example, suppose the user selected the Mansions wish list. The interface may show property cards for properties in the category for the user to choose from. The interface may show an affordance in each property card (e.g., affordance 916) for the user to select to add to the current wish list. The properties that are selected by the user (e.g., by clicking on the affordances) are added to the wish list. In some embodiments, property cards may be shown for a particular category. When the user selects a property card, the property corresponding to the property card is automatically added to a wish list for the category. This may continue until the user selects a different category.

FIG. 9G shows another view of the example user interface 900 when the user selects a different category, according to some embodiments. In this example, suppose the user selects category 918. Different properties or property cards may be shown in the property listings.

FIG. 9H shows another view of the example user interface 900 when the user selects an affordance for adding a property to a wish list, according to some embodiments. Because the last wish list (for the Mansions category) is different from the current category (Cabins category), the overlay 906 is shown to allow the user to select a wish list from current wish lists or to create a new wish list.

FIG. 9I shows another view of the example user interface 900 when the user selects a category, according to some embodiments. The system may automatically switch to the corresponding to the wish list corresponding to the category. Here, the user selects the properties corresponding to the affordances 920, 922 and 924. Some embodiments may show a notification 926 (e.g., a banner pop-up notification, sometimes referred to as a toast) each time a property is added to a wish list.

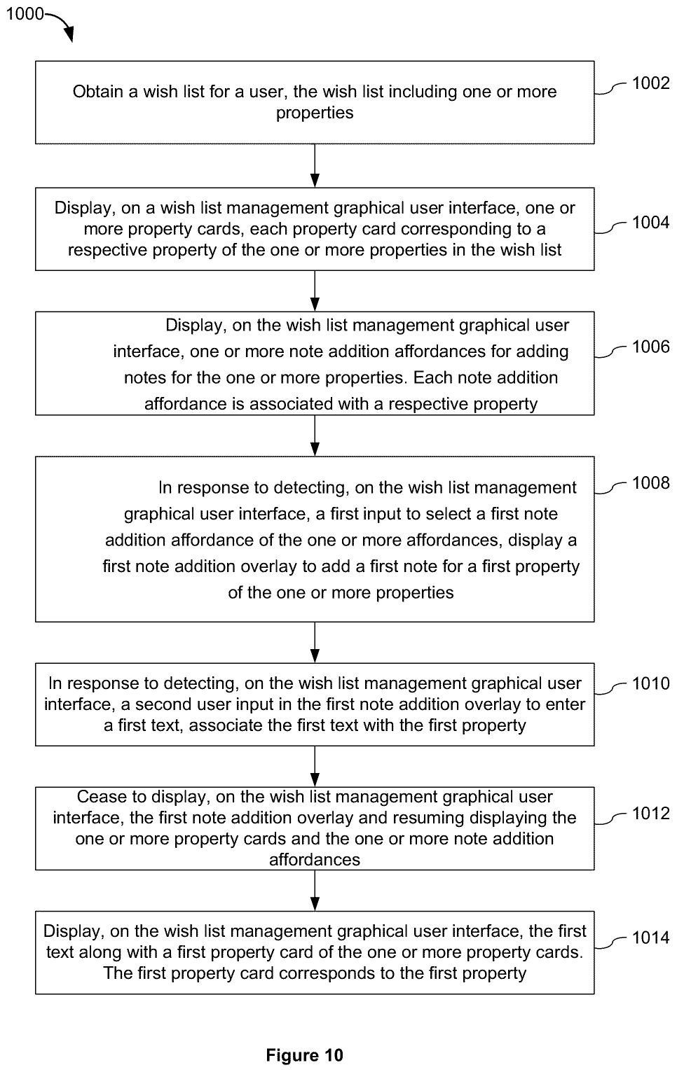

FIG. 10 shows a flow diagram of a method 1000 for organizing wish lists in an online marketplace, according to some embodiments. In some embodiments, the steps of the method 1000 may be performed by a computer (e.g., the application server 140). In some embodiments, the steps of the method 1000 may be performed by a system (e.g., the networked system 102). In some embodiments, FIG. 10 may correspond to instructions stored in a computer memory or computer-readable storage medium (e.g., memory of the application server 140). The memory may store one or more programs configured for execution by the one or more processors. For example, the operations of the method 1000 may be performed, at least in part, by the wish list management module 150 and/or the visualization module 142. In some embodiments, the steps of the method 1000 may be performed by the API server 120, the web server 122, the application server 140, and/or the database server 124.

The method may include obtaining (1002) a wish list for a user. The wish list may include one or more properties. The wish list may be a collection of data stored on a database (e.g., the memory of the application server 140) including a listing of one or more unique identifiers associated with products and/or services offered for sale at an online marketplace. The method may also include displaying (1004), on a wish list management graphical user interface (e.g., the example user interfaces 400, 500, 600, 700, 800, and/or 900), one or more property cards (e.g., the property cards 502, 504, 506, and 508). Each property card may correspond to a respective property of the one or more properties in the wish list. The method may also include displaying (1006), on the wish list management graphical user interface, one or more note addition affordances (e.g., the affordance 524) for adding notes for the one or more properties. Each note addition affordance is associated with a respective property. The method may also include, in response to detecting, on the wish list management graphical user interface, a first input from the user to select a first note addition affordance of the one or more affordances, displaying (1008) a first note addition overlay (e.g., the overlay 602) to add a first note for a first property of the one or more properties. The method may also include, in response to detecting, on the wish list management graphical user interface, a second user input in the first note addition overlay to enter a first text (e.g., entering text in the text box 604, clicking on the save affordance 610), associating (1010) the first text with the first property. The method may also include ceasing to display (1012) the first note addition overlay and resuming displaying the one or more property cards and the one or more note addition affordances, an example of which is described above in reference to FIGS. 6D and 6E, according to some embodiments. The method may also include displaying (1014), on the wish list management graphical user interface, the first text along with a first property card of the one or more property cards. The first property card corresponds to the first property. An example of displaying updated notes is described above in reference to FIG. 6E, according to some embodiments.

Some embodiments enable users to update notes, examples of which are described above in reference to FIGS. 6G, 6H, and 6I, according to some embodiments. The method may further include, in response to detecting, on the wish list management graphical user interface, a third input from the user to select the first note addition affordance, displaying a second note addition overlay (e.g., the overlay 604 shown in FIG. 6G) to add a second note for the first property. The method may also include, in response to detecting, on the wish list management graphical user interface, a fourth user input in the second note addition overlay to enter a second text, associating the second text with the first property. The method may also include ceasing to display the second note addition overlay and resuming displaying the one or more property cards and the one or more note addition affordances. The method may also include displaying, on the wish list management graphical user interface, the second text, instead of the first text, along with the first property card of the one or more property cards. The first property card may correspond to the first property.

Some embodiments enable users to sort the cards and/or property listings in the wish lists based on notes. In some embodiments, the method may further include sorting the one or more property cards based on notes corresponding to each property of the one or more properties, to obtain a sorted list of property cards. The method may also include displaying, on the wish list management graphical user interface, the one or more property cards, according to the sorted list of property cards. Although this aspect is not shown in the example user interfaces, the wish list management module 150 may include a note sorting module, to sort property cards based on added notes. Optionally, the user may search for notes via the user interface.

In some embodiments, each note addition affordance of the one or more note addition affordances may be shown adjacent to a respective property card of a respective property corresponding to the respective note addition affordance. For example, the note addition affordance 524 is shown adjacent or, or as part of the property card 502.

Some embodiments enable users to share wish list and/or shares notes, examples of which are described above in reference to FIGS. 7A and 7B, according to some embodiments. In some embodiments, the method may also include providing a share affordance on the wish list management graphical user interface. The method may also include, in response to the user selecting the share affordance, (i) displaying, on the wish list management graphical user interface, a wish list share overlay (e.g., the overlay 702) to select a share option for the user to share the wish list; and (ii) in response to the user selecting, on the wish list management graphical user interface, the share option, associating one or more other users of the online marketplace to share the wish list and/or displaying the wish list for the one or more other users. In some embodiments, associating the one or more other users of the online marketplace may be performed in response to the user (i) providing information related to the one or more other users and/or (ii) selecting a mechanism (e.g., selecting between options 704 and 706, selecting an option shown in FIG. 7B to send a link to the wish list) to share the wish list with the one or more other users, via the wish list management graphical user interface.

Some embodiments show a map alongside a wish list, examples of which are described below in reference to FIG. 5A, according to some embodiments. In some embodiments, the method may further include dividing the wish list management graphical user interface into a plurality of regions (e.g., the regions 528 and 510). The method may also include displaying the one or more property cards in a first region of the wish list management graphical user interface. The method may also include displaying a map (e.g., the map in the region 510) in a second region of the wish list management graphical user interface. The method may also include displaying a plurality of icons (e.g., the icons 530) on the map, each icon corresponding to a respective property of the one or more properties. Each icon is displayed approximately at a geographic location on the map corresponding to the respective property. In some embodiments, the first region and the second region may be displayed concurrently and adjacent to each other. In some embodiments, the first region and the second region may be displayed concurrently, and the first region is displayed above the second region (an example of which is not shown, but which may be useful, for example, when the map has a specific form or when the user prefers to see the listings on top of the map). In some embodiments, the first region and the second region may have different areas. In some embodiments, the first region and the second region may have similar areas. In some embodiments, the map may correspond to a geographic region corresponding to a location of the one or more properties in the wish list. For example, the region around LA is shown in FIG. 5A, because the property listings are in or around LA. In some embodiments, the method may further include displaying, in the first region, a subset of the one or more property cards including less than all property cards of the one or more property cards. For example, FIG. 5A shows a subset of the properties of the LA trip wish list. The method may also include displaying, in the second region, a portion of the map lesser than a whole of the map, based on an area of the second region. In some embodiments, the method may further include selecting the portion of the map (e.g., an approximate portion of the region around LA is shown in the map in FIG. 5A) so as to show locations corresponding to the subset of properties corresponding to the subset of the one or more property cards. In some embodiments, the method may further include selecting the subset of the one or more property cards based on relative importance of properties for the user. For example, the property cards 502 and 504 are above the property cards 506 and 508 because the user may prefer those when triaging properties, may have clicked on those properties more than other properties, other users may prefer those properties more than other properties, the properties are most popular, most affordable, etc. In some embodiments, a sum of areas of the plurality of regions may correspond to a screen size of a device used by the user. For example, on a mobile screen with lesser screen budget, a smaller number of property cards may be shown when compared to a desktop version.

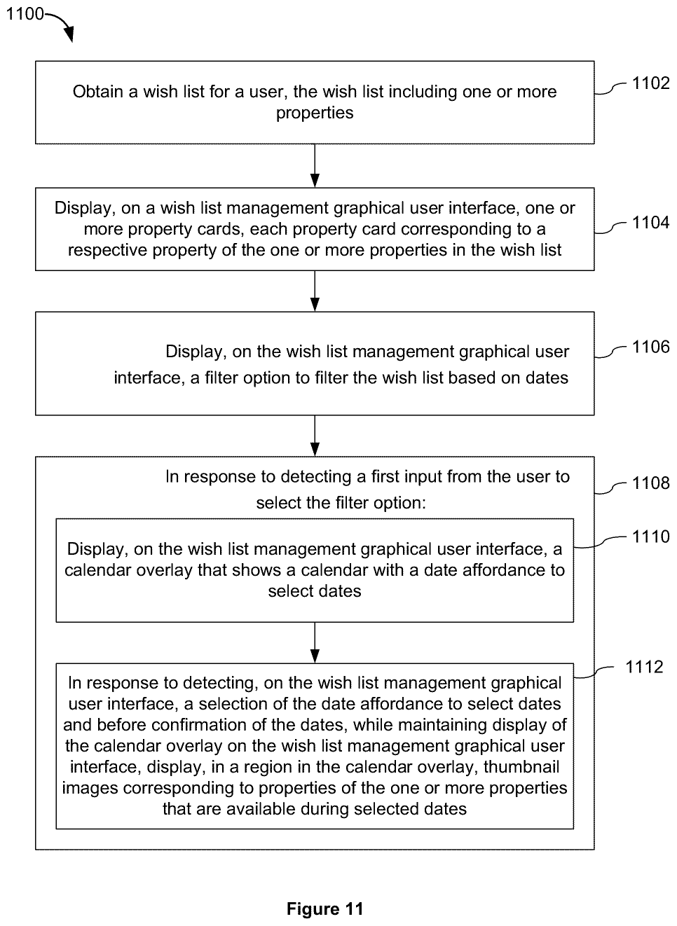

FIG. 11 shows a flow diagram of a method 1100 for organizing wish lists in an online marketplace, according to some embodiments. In some embodiments, the steps of the method 1100 may be performed by a computer (e.g., the application server 140). In some embodiments, the steps of the method 1100 may be performed by a system (e.g., the networked system 102). In some embodiments, FIG. 11 may correspond to instructions stored in a computer memory or computer-readable storage medium (e.g., memory of the application server 140). The memory may store one or more programs configured for execution by the one or more processors. For example, the operations of the method 1100 may be performed, at least in part, by the wish list management module 150 and/or the visualization module 142. In some embodiments, the steps of the method 1100 may be performed by the API server 120, the web server 122, the application server 140, and/or the database server 124. Some embodiments enable users to filter wish list based on selected dates and/or show thumbnail images for properties available during selected dates, examples of which are described above in reference to FIGS. 8A-8F, according to some embodiments.

The method may include obtaining (1102) a wish list for a user, the wish list including one or more properties. A wish list may be a collection of data stored on a database (e.g., the memory of the application server 140) including a listing of one or more unique identifiers associated with products and/or services offered for sale at an online marketplace. The method may also include displaying (1104), on a wish list management graphical user interface, one or more property cards, each property card corresponding to a respective property of the one or more properties in the wish list. The method also includes displaying (1106), on the wish list management graphical user interface, a filter option (e.g., option 836) to filter the wish list based on dates. The method also includes, in response to detecting a first input from the user to select the filter option, displaying (1108), on the wish list management graphical user interface, a calendar overlay (e.g., the overlay 802) that shows a calendar with a date affordance (.g., the affordance 806) to select dates. The method may also include, in response (1110) to the user selecting the date affordance to select dates and before confirmation of the dates from the user, while maintaining display of the calendar overlay on the wish list management graphical user interface, displaying (1112), in a region in the calendar overlay, thumbnail images (e.g., the images in the region 804) corresponding to properties of the one or more properties that are available during selected dates.

In some embodiments, the thumbnail images may be shown below the calendar. In some embodiments, the region is displayed below the calendar, an example of which is shown in FIG. 8A.

Some embodiments may filter after dates are selected by a user. In some embodiments, the method may further include, after receiving confirmation of the dates from the user: ceasing to display the calendar overlay; and displaying, on the wish list management graphical user interface, only the properties of the one or more properties that are available during the selected dates. An example is described above in reference to FIGS. 8D and 8E, according to some embodiments.

Some embodiments may update thumbnail images real-time. In some embodiments, the thumbnail images may be updated in real time in response to date changes. For example, FIGS. 8A and 8D different number of thumbnail images.

Some embodiments may show available properties in wish list followed by unavailable properties. In some embodiments, the method may further include ceasing to display the calendar overlay, and sorting and displaying, on the wish list management graphical user interface, the properties of the one or more properties that are available during the selected dates followed by other properties of the one or more properties that are not available during the selected dates. Examples of these steps are described above in reference to FIG. 8F, according to some embodiments.

Some embodiments may show number of available properties. In some embodiments, the method may further include displaying, in the region, adjacent to the thumbnail images, a number of available properties for the selected dates.

Some embodiments may enable users to select exact dates and/or dates with leeway (e.g., +/−1, +/−2, etc.) for the wish lists. In some embodiments, the method may further include displaying, in the region, one or more affordances for selecting exact dates or dates with leeway. In some embodiments, the method may further include, in response to the user selecting an affordance corresponding to dates with leeway, updating the region with an updated set of thumbnail images corresponding to an updated set of properties of the one or more properties that are available during the dates with leeway. Examples are described above in reference to FIGS. 8A-8D, according to some embodiments.

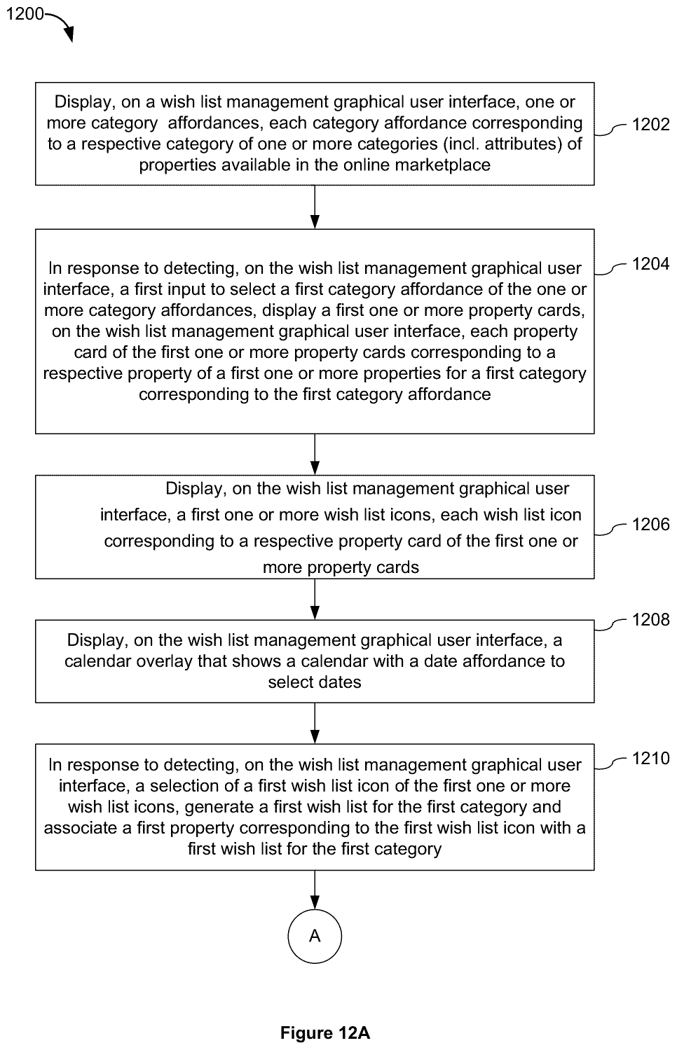

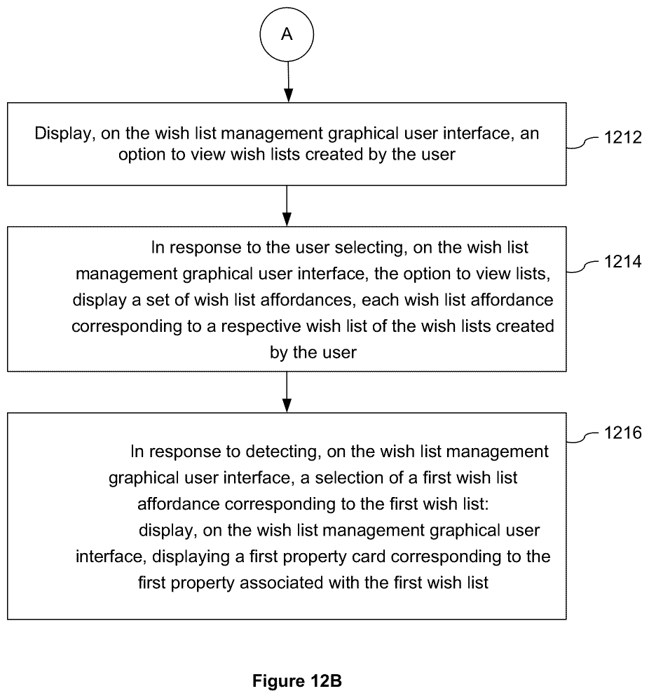

FIGS. 12A and 12B show a flow diagram of a method 1200 for organizing wish lists in an online marketplace, according to some embodiments. In some embodiments, the steps of the method 1200 may be performed by a computer (e.g., the application server 140). In some embodiments, the steps of the method 1200 may be performed by a system (e.g., the networked system 102). In some embodiments, FIGS. 12A and 12B correspond to instructions stored in a computer memory or computer-readable storage medium (e.g., memory of the application server 140). The memory may store one or more programs configured for execution by the one or more processors. For example, the operations of the method 1200 may be performed, at least in part, by the wish list management module 150 and/or the visualization module 142. In some embodiments, the steps of the method 1200 may be performed by the API server 120, the web server 122, the application server 140, and/or the database server 124. Some embodiments enable users to save properties to wish lists. A wish list may be a collection of data stored on a database (e.g., the memory of the application server 140) including a listing of one or more unique identifiers associated with products and/or services offered for sale at an online marketplace.

Referring to FIG. 12A, the method may include displaying (1202), on a wish list management graphical user interface, one or more category affordances (e.g., affordances for categories in FIG. 9A). Each category affordance may correspond to a respective category of one or more categories of properties available in the online marketplace. The method may also include, in response to detecting, on the wish list management graphical user interface, a first input from a user to select a first category affordance of the one or more category affordances, displaying (1206) a first one or more property cards, on the wish list management graphical user interface. Each property card of the first one or more property cards may correspond to a respective property of a first one or more properties for a first category corresponding to the first category affordance. For example, FIG. 9A shows properties for the category Mansions. The method may also include, displaying (1208), on the wish list management graphical user interface, a first one or more wish list icons (e.g., icons 928-2, . . . , 928-14), each wish list icon corresponding to a respective property card of the first one or more property cards. The method may also include, in response to detecting, on the wish list management graphical user interface, a selection by a user of a first wish list icon of the first one or more wish list icons, generating a first wish list for the first category and associating a first property (1210) corresponding to the first wish list icon with a first wish list for the first category. For example, the user selects the affordance 916 in FIG. 9F.

Referring next to FIG. 12B, the method may also include, displaying (1212), on the wish list management graphical user interface, an option to view wish lists created by the user. The method may also include, in response to detecting, the user selecting, on the wish list management graphical user interface, the option to view lists, displaying (1214) a set of wish list affordances (or wish list cards, similar to property cards), each wish list affordance corresponding to a respective wish list of the wish lists created by the user. The method may also include, in response to detecting, the user selecting, on the wish list management graphical user interface, a first wish list affordance corresponding to the first wish list, displaying (1216), on the wish list management graphical user interface, a first property card corresponding to the first property associated with the first wish list.

Some embodiments may enable users to switch between wish lists. In some embodiments, the method may further include, in response to detecting, on the wish list management graphical user interface, a second input from the user to select a second category affordance of the one or more category affordances, displaying a second one or more property cards, on the wish list management graphical user interface. Each property card of the second one or more property cards may correspond to a respective property of a second one or more properties for a second category corresponding to the second category affordance. The method may also include displaying, on the wish list management graphical user interface, a second one or more icons, each icon of the second one or more icons corresponding to a respective property card of the second one or more property cards. The method may also include, in response to detecting, the user selecting, on the wish list management graphical user interface, a third icon of the second one or more icons, associating a third property corresponding to the third icon with a second wish list for the second category. The method may also include, in response to detecting, the user selecting, on the wish list management graphical user interface, a fourth icon of the second one or more icons, associating a fourth property corresponding to the fourth icon with the second wish list for the first category. The method may also include, in response to detecting, the user selecting, on the wish list management graphical user interface, the option to view lists, displaying the set of wish list affordances including the first wish list and the second wish list. Examples of switching between wish lists and categories are described above in reference to FIGS. 9F, 9G, 9H and 9I, according to some embodiments.

Some embodiments may enable users to add to a wish list for a category. In some embodiments, the method may further include, in response to detecting, the user selecting, on the wish list management graphical user interface, a second icon of the first one or more wish list icons, associating a second property corresponding to the second icon with the first wish list for the first category. An example is described above in reference to FIGS. 9H and 9I, according to some embodiments. In some embodiments, a first wish list with a first set of properties for a first category already exists and then in response to a selection in a second category, the method includes automatically creating a wish list.

It will be understood that, although the terms first, second, etc., are, in some instances, used herein to describe various elements, these elements should not be limited by these terms. These terms are only used to distinguish one element from another. For example, a first widget could be termed a second widget, and, similarly, a second widget could be termed a first widget, without departing from the scope of the various described implementations. The first widget and the second widget are both widgets, but they are not the same condition unless explicitly stated as such.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen to best explain the principles underlying the claims and their practical applications, to thereby enable others skilled in the art to best use the implementations with various modifications as are suited to the particular uses contemplated.

What is claimed is:

1. A method of organizing wish lists in an online marketplace, the method comprising:
at a computing system having one or more processors and memory storing one or more programs configured for execution by the one or more processors:
displaying, on a wish list management graphical user interface, one or more category affordances, each category affordance corresponding to a respective category of one or more categories of properties available in the online marketplace;
in response to detecting, on the wish list management graphical user interface, a first input from a user to select a first category affordance of the one or more category affordances, displaying a first one or more property cards, on the wish list management graphical user interface, each property card of the first one or more property cards corresponding to a respective property of a first one or more properties for a first category corresponding to the first category affordance;
displaying, on the wish list management graphical user interface, a first one or more wish list icons, each wish list icon corresponding to a respective property card of the first one or more property cards;
in response to detecting, on the wish list management graphical user interface, a selection by a user of a first wish list icon of the first one or more wish list icons, generating a first wish list for the first category and associating a first property corresponding to the first wish list icon with a first wish list for the first category;
displaying, on the wish list management graphical user interface, an option to view wish lists created by the user;
in response to detecting, on the wish list management graphical user interface, the user selecting the option to view lists, displaying a set of wish list affordances, each wish list affordance corresponding to a respective wish list of the wish lists created by the user; and
in response to detecting, on the wish list management graphical user interface, the user selecting a first wish list affordance corresponding to the first wish list:
displaying, on the wish list management graphical user interface, a first property card corresponding to the first property associated with the first wish list.

2. The method of claim 1, further comprising:
in response to detecting, on the wish list management graphical user interface, a second input from the user to select a second category affordance of the one or more category affordances, displaying a second one or more property cards, on the wish list management graphical user interface, each property card of the second one or more property cards corresponding to a respective property of a second one or more properties for a second category corresponding to the second category affordance;
displaying, on the wish list management graphical user interface, a second one or more icons, each icon of the second one or more icons corresponding to a respective property card of the second one or more property cards;
in response to detecting, on the wish list management graphical user interface, the user selecting a third icon of the second one or more icons, associating a third property corresponding to the third icon with a second wish list for the second category;
in response to detecting, on the wish list management graphical user interface, the user selecting a fourth icon of the second one or more icons, associating a fourth property corresponding to the fourth icon with the second wish list for the first category; and
in response to detecting, on the wish list management graphical user interface, the user selecting the option to view lists, displaying the set of wish list affordances including the first wish list and the second wish list.

3. The method of claim 1, further comprising:
in response to the user selecting, on the wish list management graphical user interface, a second icon of the first one or more wish list icons, associating a second property corresponding to the second icon with the first wish list for the first category.

4. A method of organizing wish lists in an online marketplace, the method comprising:
at a computing system having one or more processors and memory storing one or more programs configured for execution by the one or more processors:
obtaining a wish list for a user, the wish list including one or more properties;
displaying, on a wish list management graphical user interface, one or more property cards, each property card corresponding to a respective property of the one or more properties in the wish list;
displaying, on the wish list management graphical user interface, one or more note addition affordances for adding notes for the one or more properties, wherein each note addition affordance is associated with a respective property;
in response to detecting, on the wish list management graphical user interface, a first input from the user to select a first note addition affordance of the one or more affordances, displaying a first note addition overlay to add a first note for a first property of the one or more properties;
in response to detecting, on the wish list management graphical user interface, a second user input in the first note addition overlay to enter a first text, associating the first text with the first property;
ceasing to display, on the wish list management graphical user interface, the first note addition overlay and resuming displaying the one or more property cards and the one or more note addition affordances; and
displaying, on the wish list management graphical user interface, the first text along with a first property card of the one or more property cards, wherein the first property card corresponds to the first property.

5. The method of claim 4, further comprising:
in response to detecting, on the wish list management graphical user interface, a third input from the user to select the first note addition affordance, displaying a second note addition overlay to add a second note for the first property;
in response to detecting, on the wish list management graphical user interface, a fourth user input in the second note addition overlay to enter a second text, associating the second text with the first property;
ceasing to display the second note addition overlay and resuming displaying the one or more property cards and the one or more note addition affordances; and
displaying, on the wish list management graphical user interface, the second text, instead of the first text, along with the first property card of the one or more property cards, wherein the first property card corresponds to the first property.

6. The method of claim 4, further comprising:
sorting the one or more property cards based on notes corresponding to each property of the one or more properties, to obtain a sorted list of property cards; and
displaying, on the wish list management graphical user interface, the one or more property cards, according to the sorted list of property cards.

7. The method of claim 4, wherein each note addition affordance of the one or more note addition affordances is shown adjacent to a respective property card of a respective property corresponding to the respective note addition affordance.

8. The method of claim 4, further comprising:
providing a share affordance on the wish list management graphical user interface; and
in response to the user selecting the share affordance:
displaying, on the wish list management graphical user interface, a wish list share overlay to select a share option for the user to share the wish list; and
in response to the user selecting, on the wish list management graphical user interface, the share option, associating one or more other users of the online marketplace to share the wish list and/or displaying the wish list for the one or more other users.

9. The method of claim 8, wherein associating the one or more other users of the online marketplace is performed in response to the user (i) providing information related to the one or more other users and/or (ii) selecting a mechanism to share the wish list with the one or more other users, via the wish list management graphical user interface.

10. The method of claim 4, further comprising:
dividing the wish list management graphical user interface into a plurality of regions;
displaying the one or more property cards in a first region of the wish list management graphical user interface;
displaying a map in a second region of the wish list management graphical user interface; and
displaying a plurality of icons on the map, each icon corresponding to a respective property of the one or more properties, wherein each icon is displayed approximately at a geographic location on the map corresponding to the respective property.

11. The method of claim 10, wherein the first region and the second region are displayed concurrently and adjacent to each other.

12. The method of claim 10, wherein the first region and the second region are displayed concurrently, and wherein the first region is displayed above the second region.

13. The method of claim 10, wherein the first region and the second region have different areas.

14. The method of claim 10, wherein the first region and the second region have similar areas.

15. The method of claim 10, wherein the map corresponds to a geographic region corresponding to a location of the one or more properties in the wish list.

16. The method of claim 10, further comprising:
displaying, in the first region, a subset of the one or more property cards including less than all property cards of the one or more property cards; and
displaying, in the second region, a portion of the map lesser than a whole of the map, based on an area of the second region.

17. The method of claim 16, further comprising:
selecting the portion of the map so as to show locations corresponding to the subset of properties corresponding to the subset of the one or more property cards.

18. The method of claim 16, further comprising:
selecting the subset of the one or more property cards based on relative importance of properties for the user.

19. The method of claim 10, wherein a sum of areas of the plurality of regions corresponds to a screen size of a device used by the user.

20. A method of organizing wish lists in an online marketplace, the method comprising:
at a computing system having one or more processors and memory storing one or more programs configured for execution by the one or more processors:
obtaining a wish list for a user, the wish list including one or more properties;
displaying, on a wish list management graphical user interface, one or more property cards, each property card corresponding to a respective property of the one or more properties in the wish list;
displaying, on the wish list management graphical user interface, a filter option to filter the wish list based on dates; and
in response to detecting a first input from the user to select the filter option:
displaying, on the wish list management graphical user interface, a calendar overlay that shows a calendar with a date affordance to select dates; and
in response to detecting, on the wish list management graphical user interface, the user selecting the date affordance to select dates and before confirmation of the dates from the user:
while maintaining display of the calendar overlay on the wish list management graphical user interface, displaying, in a region in the calendar overlay, thumbnail images corresponding to properties of the one or more properties that are available during selected dates.

21. The method of claim 20, wherein the region is displayed below the calendar.

22. The method of claim 20, further comprising:
after receiving confirmation of the dates from the user:
ceasing to display the calendar overlay; and
displaying, on the wish list management graphical user interface, only the properties of the one or more properties that are available during the selected dates.

23. The method of claim 20, wherein the thumbnail images are updated in real time in response to date changes.

24. The method of claim 20, further comprising:
ceasing to display the calendar overlay; and
sorting and displaying, on the wish list management graphical user interface, the properties of the one or more properties that are available during the selected dates followed by other properties of the one or more properties that are not available during the selected dates.

25. The method of claim 20, further comprising:
displaying, in the region, adjacent to the thumbnail images, a number of available properties for the selected dates.

26. The method of claim 20, further comprising:
displaying, in the region, one or more affordances for selecting exact dates or dates with leeway.

27. The method of claim 26, further comprising:
in response to the user selecting an affordance corresponding to dates with leeway, updating the region with an updated set of thumbnail images corresponding to an updated set of properties of the one or more properties that are available during the dates with leeway.

28. A system comprising a server including one or more processors and memory storing one or more programs to be executed by the one or more processors, the one or more programs including instructions for: displaying, on a wish list management graphical user interface, one or more category affordances, each category affordance corresponding to a respective category of one or more categories of properties available in the online marketplace;
in response to detecting, on the wish list management graphical user interface, a first input from a user to select a first category affordance of the one or more category affordances, displaying a first one or more property cards, on the wish list management graphical user interface, each property card of the first one or more property cards corresponding to a respective property of a first one or more properties for a first category corresponding to the first category affordance;
displaying, on the wish list management graphical user interface, a first one or more wish list icons, each wish list icon corresponding to a respective property card of the first one or more property cards;
in response to detecting, on the wish list management graphical user interface, a selection by a user of a first wish list icon of the first one or more wish list icons, generating a first wish list for the first category and associating a first property corresponding to the first wish list icon with a first wish list for the first category;
displaying, on the wish list management graphical user interface, an option to view wish lists created by the user;
in response to detecting, on the wish list management graphical user interface, the user selecting the option to view lists, displaying a set of wish list affordances, each wish list affordance corresponding to a respective wish list of the wish lists created by the user; and
in response to detecting, on the wish list management graphical user interface, the user selecting a first wish list affordance corresponding to the first wish list:
displaying, on the wish list management graphical user interface, a first property card corresponding to the first property associated with the first wish list.

29. A non-transitory computer readable storage medium storing one or more programs configured for execution by a computer system having a display, one or more processors, and memory, the one or more programs comprising instructions for:
displaying, on a wish list management graphical user interface, one or more category affordances, each category affordance corresponding to a respective category of one or more categories of properties available in the online marketplace;
in response to detecting, on the wish list management graphical user interface, a first input from a user to select a first category affordance of the one or more category affordances, displaying a first one or more property cards, on the wish list management graphical user interface, each property card of the first one or more property cards corresponding to a respective property of a first one or more properties for a first category corresponding to the first category affordance;
displaying, on the wish list management graphical user interface, a first one or more wish list icons, each wish list icon corresponding to a respective property card of the first one or more property cards;
in response to detecting, on the wish list management graphical user interface, a selection by a user of a first wish list icon of the first one or more wish list icons, generating a first wish list for the first category and associating a first property corresponding to the first wish list icon with a first wish list for the first category;
displaying, on the wish list management graphical user interface, an option to view wish lists created by the user;
in response to detecting, on the wish list management graphical user interface, the user selecting the option to view lists, displaying a set of wish list affordances, each wish list affordance corresponding to a respective wish list of the wish lists created by the user; and
in response to detecting, on the wish list management graphical user interface, the user selecting a first wish list affordance corresponding to the first wish list:
displaying, on the wish list management graphical user interface, a first property card corresponding to the first property associated with the first wish list.
